(19) United States
(12) Patent Application Publication
(10) Pub. No.: US 2024/0034306 A1
(43) Pub. Date: Feb. 1, 2024

(54) PARKING ASSISTANCE DEVICE AND PARKING ASSISTANCE METHOD

(71) Applicant: Panasonic Intellectual Property Management Co., Ltd., Osaka (JP)

(72) Inventors: Yudai ISHIBASHI, KANAGAWA (JP); Yoshimasa OKABE, KANAGAWA (JP); Masayuki FUKUYAMA, OSAKA (JP); Ryo OTSUKI, NARA (JP)

(73) Assignee: Panasonic Intellectual Property Management Co., Ltd., Osaka (JP)

(21) Appl. No.: 18/217,221

(22) Filed: Jun. 30, 2023

(30) Foreign Application Priority Data
Jul. 29, 2022 (JP) 2022-122142

(51) Int. Cl. B60W 30/06; G06V 20/58

(52) U.S. Cl. CPC B60W 30/06; G06V 20/586; B60W 2420/42; B60W 2554/404; B60W 2420/54

(57) ABSTRACT

A parking assistance device includes a hardware processor coupled to a memory. The hardware processor receives a camera image and performs image processing with the camera image as an input. The hardware processor senses a situation around a vehicle on the basis of the camera image or a sensing image generated by the image processing. The hardware processor performs parking assistance including a plurality of stages on the basis of the situation around the vehicle. The hardware processor restricts the image processing in accordance with the stages.

### CROSS-REFERENCE TO RELATED APPLICATIONS

This application is based upon and claims the benefit of priority from Japanese Patent Application No. 2022-122142, filed on Jul. 29, 2022, the entire contents of which are incorporated herein by reference.

### FIELD

The present disclosure relates generally to a parking assistance device and a parking assistance method.

### BACKGROUND

In the related art, an advanced automatic driving vehicle has been known. The automatic driving vehicle automatically travels to a set destination, arrives at the destination, and starts automatic parking from a time point of entering a parking lot in a site. In the first stage of such automatic parking, in order to detect a vacant parking frame (a parking frame in which no vehicle is parking out of parking frames provided in a parking lot), the automatic driving vehicle performs “detection traveling” of traveling on a passage in a parking lot while performing parking frame sensing using an in-vehicle camera.

For example, a patent literature JP 2018-39294 A discloses a parking assistance device that performs detection traveling by controlling a steering angle such that a white line (hereinafter, also referred to as a parking frame line) constituting a parking frame falls within a range where the parking frame is sensed.

It is known that when the parking frame sensing process as described above is performed, an electric control unit (ECU) that performs the process generates large amount of heat. The camera image captured by the in-vehicle camera is subjected to image processing by the LSI in the ECU, and a parking frame is detected from the camera image.

The amount of heat generated by the image processing is proportional to the number of pixels to be processed, so that the amount of heat generated increases when the range where the parking frame described above is sensed is widened. In addition, when a higher-definition camera is used, even if the range where the parking frame described above is sensed is the same, the number of pixels included therein increases, and thus the amount of heat generated increases.

Heat generated by the image processing is released from the LSI into the ECU. However, the ECU includes an exterior having a watertight structure, and does not have heat dissipation means other than heat conduction. Therefore, most of the heat generated in the LSI is accumulated inside, and the temperature in the ECU rises.

In addition, the LSI has a guaranteed operating temperature. When the LSI has a high temperature exceeding the guaranteed operating temperature, an operation may be abnormal or the LSI may be physically self-destructed. Therefore, when the temperature rises, in order to avoid an abnormal situation, the ECU is required to stop all the functions of the ECU or stop processing with a large amount of heat generated, namely, stop the parking frame sensing. Therefore, for example, when a large parking lot is almost full, the time until the vehicle encounters the vacant parking frame is long.

Therefore, the temperature in the ECU is high before the vacant parking frame is detected, and there is a possibility that the automatic parking function cannot be used until the LSI cools down.

### SUMMARY

A parking assistance device according to the present disclosure includes a hardware processor coupled to a memory. The hardware processor is configured to receive a camera image and perform image processing with the camera image as an input. The hardware processor is configured to sense a situation around a vehicle on the basis of the camera image or a sensing image generated by the image processing. The hardware processor is configure to perform parking assistance including a plurality of stages on the basis of the situation around the vehicle. The hardware processor is configured to restrict the image processing in accordance with the stages.

### BRIEF DESCRIPTION OF THE DRAWINGS

FIG. 1 is a block diagram illustrating an example of a configuration of a vehicle equipped with a parking assistance system according to the first embodiment;

FIG. 2 is a block diagram illustrating a configuration example of the parking assistance system according to the first embodiment;

FIG. 3 is a block diagram illustrating a configuration example of a parking assistance ECU according to the first embodiment;

FIG. 4 is a diagram for explaining an example of heat generation of a chip of the parking assistance ECU according to the first embodiment;

FIG. 5 is a diagram for describing an example of a relationship between processing performed by the parking assistance ECU according to the first embodiment and a temperature of a chip;

FIG. 6A is a diagram for describing an example of detection traveling (Stage 1) according to the first embodiment;

FIG. 6B is a diagram for describing an example of parking route calculation (Stage 1.5) according to the first embodiment;

FIG. 6C is a diagram for describing an example of the parking traveling (Stage 2) according to the first embodiment;

FIG. 7A is a diagram for describing an example of detection traveling using a side sonar according to the first embodiment;

FIG. 7B is a diagram for describing an example of detection traveling using the side sonar according to the first embodiment;

FIG. 7C is a diagram for describing an example of detection traveling using the side sonar according to the first embodiment;

FIG. 8A is a diagram for describing an example of processing of sensing a parking frame candidate by the side sonar according to the first embodiment;

FIG. 8B is a diagram for describing an example of processing of sensing the parking frame candidate by the side sonar according to the first embodiment;

FIG. 9 is a diagram illustrating an example of a relationship between a distance traveled by the vehicle and a sensing distance by the side sonar according to the first embodiment;

FIG. 10A is a diagram for describing an example of processing of sensing a parking frame candidate by a front corner sonar according to the first embodiment;

FIG. 10B is a diagram for describing an example of processing of sensing a parking frame candidate by the front corner sonar according to the first embodiment;

FIG. 11 is a diagram illustrating an example of a relationship between a distance traveled by the vehicle and a sensing distance by the front corner sonar according to the first embodiment;

FIG. 12A is a diagram for describing an example of parking traveling according to the first embodiment;

FIG. 12B is a diagram for describing an example of parking traveling according to the first embodiment;

FIG. 13A is a diagram for describing an example of a generation process for a peripheral display image according to the first embodiment;

FIG. 13B is a diagram for describing an example of a generation process for the peripheral display image according to the first embodiment;

FIG. 14 is a flowchart illustrating an example of processing performed by the parking assistance ECU according to the first embodiment;

FIG. 15A is a diagram for describing an example of a parking frame sensing process using free space sensing according to the second embodiment;

FIG. 15B is a diagram for describing an example of a parking frame sensing process using free space sensing according to the second embodiment;

FIG. 15C is a diagram for describing an example of a parking frame sensing process using free space sensing according to the second embodiment;

FIG. 16A is a diagram for describing an example of processing of restricting a sensing range of a parking frame sensing unit according to the second embodiment;

FIG. 16B is a diagram for describing an example of processing of restricting the sensing range of the parking frame sensing unit according to the second embodiment;

FIG. 16C is a diagram for describing an example of processing of restricting the sensing range of the parking frame sensing unit according to the second embodiment;

FIG. 17A is a diagram for describing an example of detection traveling in a case where large and small sensing ranges according to the second embodiment are mixed;

FIG. 17B is a diagram for describing an example of detection traveling in a case where the large and small sensing ranges according to the second embodiment are mixed;

FIG. 18A is a diagram illustrating an example of processing of determining presence or absence of a parked vehicle according to the second embodiment;

FIG. 18B is a diagram illustrating an example of processing of determining presence or absence of a parked vehicle according to the second embodiment;

FIG. 19 is a flowchart illustrating an example of processing performed by a parking assistance ECU according to the second embodiment;

FIG. 20A is a diagram for describing an example of processing of determining presence or absence of a parked vehicle by sensing an image of a license plate of the parked vehicle according to the third embodiment; and

FIG. 20B is a diagram for describing an example of processing of determining presence or absence of a parked vehicle by sensing an image of a license plate of the parked vehicle according to the third embodiment.

### DETAILED DESCRIPTION

### First Embodiment

Hereinafter, a parking assistance device according to a first embodiment of the present disclosure will be described with reference to the drawings.

Configuration of Vehicle

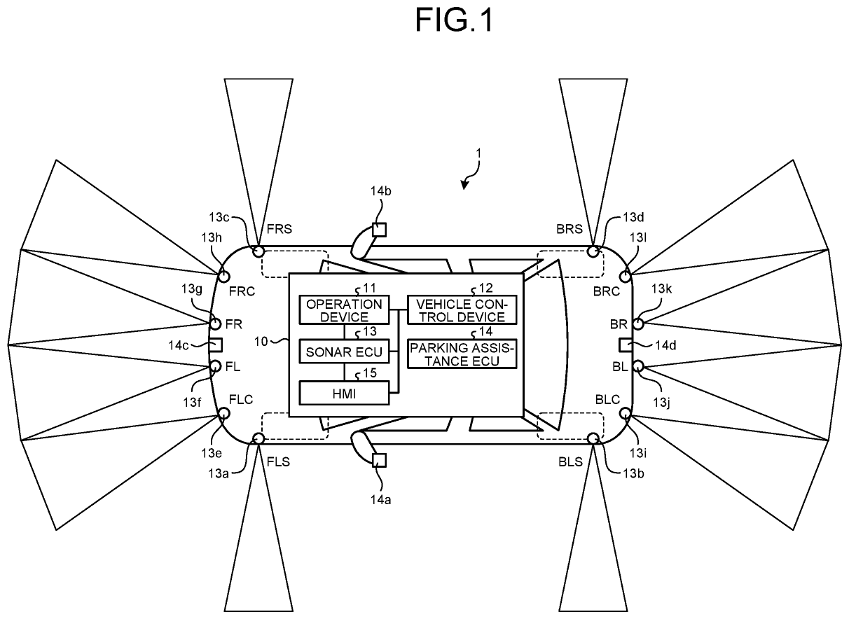

First, a configuration of a vehicle in which a parking assistance device according to first embodiment is installed will be described. FIG. 1 is a diagram illustrating an example of a configuration of a vehicle 1 in which a parking assistance system 10 according to a first embodiment is installed. As illustrated in FIG. 1, the vehicle 1 includes an operation device 11, a vehicle control device 12, a sonar ECU 13, a parking assistance ECU 14, and a human machine interface (HMI) device 15.

In the present embodiment, the parking assistance system 10 includes the operation device 11, the vehicle control device 12, the sonar ECU 13, the parking assistance ECU 14, and the HMI device 15. Note that another device may be further installed in the vehicle 1. Although the operation device 11, the vehicle control device 12, the sonar ECU 13, the parking assistance ECU 14, and the HMI device 15 are illustrated as separate devices in FIG. 1, some or all of these devices may be integrated.

The operation device 11, the vehicle control device 12, the sonar ECU 13, the parking assistance ECU 14, and the HMI device 15 will be described later.

As illustrated in FIG. 1, twelve sonar sensors 13a to 13l are installed in the vehicle 1. For example, on the left side of the vehicle 1, the sonar sensor 13a is installed on the front left side (FLS) of the vehicle 1, and the sonar sensor 13b is installed on the back left side (BLS) of the vehicle 1.

On the right side of the vehicle 1, the sonar sensor 13c is installed on the front right side (FRS) of the vehicle 1, and the sonar sensor 13d is installed on the back right side (BRS) of the vehicle 1. These four sonar sensors are also referred to as side sonars as they sense obstacles on the side of the vehicle.

On the front side of the vehicle 1, the sonar sensor 13e on the front left corner (FLC), the sonar sensor 13f on the front left (FL), the sonar sensor 13g on the front right (FR), and the sonar sensor 13h on the front right corner (FRC) are installed in this order from the left side when viewed in the forward direction of the vehicle 1.

The sonar sensor 13f and the sonar sensor 13g provided inner side detect an obstacle in the traveling direction when the vehicle 1 travels straight. In addition, the sonar sensor 13e and the sonar sensor 13h provided outer side detect an obstacle in a turning direction when the vehicle 1 turns. The sonar sensors 13e and 13h are also referred to as corner sonars. The sensing ranges of the four sonar sensors 13e, 13f, 13g, and 13h are installed so as to overlap with one another.

Additionally, on the back side of the vehicle 1, the sonar sensor 13i on the back left corner (BLC), the sonar sensor 13j on the back left (BL), the sonar sensor 13k on the back right (BR), and the sonar sensor 13l on the back right Corner (BRC) are installed in this order from the left side when viewed in the forward direction of the vehicle 1.

The sonar sensor 13j and the sonar sensor 13k provided inner side detect an obstacle in the traveling direction when the vehicle 1 moves backward. In addition, the sonar sensor 13i and the sonar sensor 13l provided outer side detect an obstacle in a turning direction when the vehicle 1 moves backward and turns. The sonar sensors 13i and 13l are also referred to as corner sonars. Note that the sensing ranges of the four sonar sensors 13i, 13j, 13k, and 13l are installed so as to overlap with one another.

The sensing ranges of the sonar sensors 13a, 13b, 13c, and 13d installed on the sides of the vehicle 1 are set narrower than the sensing ranges of the sonar sensors installed in the front and the rear of the vehicle 1. This is to improve the resolution of the position when the parking assistance system 10 detects the parking space on the side of the vehicle 1 by reducing the overlapping of the sensing ranges of the side sonars when the vehicle 1 moves as much as possible.

In addition, each sonar sensor is installed at a height and a depression angle at which it is easy to detect surrounding obstacles when the vehicle 1 is parked. Note that the installation places and the number of the sonar sensors 13a to 13l are not limited to the example illustrated in FIG. 1.

As illustrated in FIG. 1, four cameras 14a to 14d are installed in the vehicle 1. For example, the camera 14a is installed at the lower part of a side-view mirror on the left side of the vehicle 1. The camera 14a can image the surroundings including left of the vehicle 1. The camera 14b is installed at the lower part of a side-view mirror on the right side of the vehicle 1. The camera 14b can image the surroundings including right of the vehicle 1.

In addition, the camera 14c is installed at an end portion on the front side of the vehicle 1. The camera 14c can image the surroundings including in front of the vehicle 1. In addition, the camera 14d is installed at an end portion on the back side of the vehicle 1. The camera 14d can image the surroundings including behind the vehicle 1. Note that the installation places and the number of the cameras 14a to 14d are not limited to the example illustrated in FIG. 1.

Configuration of Parking Assistance System

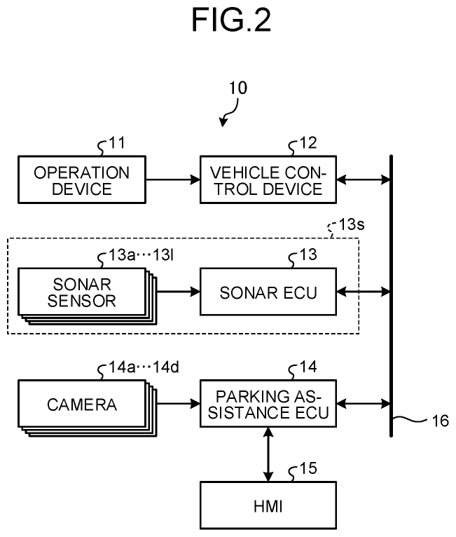

Next, a configuration of the parking assistance system 10 will be described. FIG. 2 is a diagram illustrating an example of a configuration of a parking assistance system 10 according to the first embodiment. As illustrated in FIG. 2, the parking assistance system 10 includes the operation device 11, the vehicle control device 12, a sonar system 13s (sonar ECU 13 and sonar sensors 13a to 13l), the parking assistance ECU 14, the cameras 14a to 14d, and the HMI device 15.

The operation device 11, the vehicle control device 12, the sonar ECU 13, the sonar sensors 13a to 13l, the parking assistance ECU 14, the cameras 14a to 14d, and the HMI device 15 are mutually connected by a LAN (in-vehicle LAN) 16. The LAN 16 may be wireless or wired.

The operation device 11 is a device for a driver to operate the vehicle 1. More specifically, the driver operates the operation device 11 to perform an operation for driving the vehicle 1 and an operation for using the parking assistance function. Examples of the operation device 11 include a physical switch on a panel of the driver's seat, a soft switch displayed on a display device such as the HMI device 15, a steering wheel, various pedals, and the like.

The vehicle control device 12 is a device that controls a vehicle speed, a steering angle, and the like of the vehicle 1.

When the driver operates the operation device 11 to drive the vehicle 1, the vehicle control device 12 receives the operation. In the normal manual driving mode, the vehicle control device 12 drives a motor (not illustrated) in accordance with the operation information to control the vehicle speed and the steering angle, and at the same time, output the operation information and the vehicle information such as the vehicle speed and the steering angle to the LAN 16. In the parking assistance mode, the vehicle control device 12 receives instructions of the speed and the steering angle from the parking assistance ECU 14 via the LAN 16, and controls the speed and the steering angle in accordance with the instructions. The parking assistance mode is, in principle, automatic driving, and the driver does not need to drive (for example, operating a handle or various pedals) the vehicle 1, but can intervene in the driving by operating a steering wheel or various pedals. That is, the vehicle control device 12 receives the driver's operation even in the parking assistance mode, and gives priority to the driver's operation over the instruction of the parking assistance ECU 14.

The sonar system 13s includes the sonar sensors 13a to 13l and the sonar ECU 13. The sonar ECU 13 is a device that controls the sonar sensors 13a to 13l. The sonar sensors 13a to 13l transmit sound waves in accordance with the control of the sonar ECU 13, to transmit information on the time difference until the reflected wave is received to the sonar ECU 13. The information about the time difference corresponds to a round-trip distance when sound wave travels to the detected obstacle, and thus may be read as a sensing distance.

The sonar ECU 13 integrates information (sensing distances) about the time difference from the plurality of sonar sensors (sonar sensors 13a to 13l) disposed on the outer peripheral portion of the vehicle 1, and identifies a distance between the obstacle reflecting the sound wave and the vehicle 1 and a position of the obstacle. The sonar ECU 13 transmits information on the identified obstacle to the parking assistance ECU 14 via the LAN 16. Note that the distance to the obstacle means that no obstacle is detected up to the distance, and thus the information on the obstacle may be read as information on a space without the obstacle.

The parking assistance ECU 14 is a device that assists parking of the vehicle 1. In the present specification, the parking assistance includes a route calculation process for setting at least a target parking position and a parking route to the target parking position, and parking traveling assistance of assisting parking traveling to travel to the target parking position along the parking route. In addition, the parking assistance may include detection traveling assistance of assisting detection traveling for traveling to detect a parking available space.

In addition, the traveling assistance including the parking traveling assistance and the detection traveling assistance may be automatic driving control of automatically controlling steering or acceleration/deceleration, or may be manual driving assistance of controlling at least one of steering or acceleration/deceleration by presenting an instruction or an index to a driver. In the present specification, it is described that the detection traveling is performed by semi-automatic driving in which only the vehicle speed is automatically controlled, and the parking traveling is performed by fully automatic driving.

The parking assistance ECU 14 includes an image input unit. For example, the parking assistance ECU 14 includes an image input unit configured to receive a camera image, and performs image processing, sensing, and parking assistance. The parking assistance ECU 14 is an example of a parking assistance device. Note that the parking assistance device may or may not include the sonar ECU 13 described above.

In the present specification, the image processing includes a sensing process for sensing a surrounding situation of the vehicle 1 on the basis of a camera image and an image generation process for generating an image indicating the surroundings of the vehicle 1 on the basis of the camera image. In addition, in the present specification, the image indicating the surroundings of the vehicle 1 includes a display image to be output to the display device and a sensing image to be an input of the sensing process.

Moreover, in the present specification, the sensing process is a “process for the purpose of obtaining a sensing result that a target object has been detected”. For example, the sensing process includes image processing of the purpose of detecting a free space or a parking frame. In addition, “detection for detecting something” is “detection for the purpose of obtaining a sensing result that something has been detected”.

In addition, in the present specification, detection refers to “detection of a target object being present, as a sensing result”. For example, when a sensing result that “a free space or a parking frame is present” is obtained, is referred to as “detected”.

In addition, in the present specification, the result of detecting the presence or absence is divided into a case of “detected” and a case of “not detected”. That is, the result of detecting the presence or absence is divided into “a case of detected as a result of detection” and “a case of performing detection but not detected”. For example, “when detecting something” refers to “when performing detection for the purpose of obtaining a sensing result that something has been detected”. Therefore, it is not necessarily meant that “detection of something is being performed”, but is rather meant that “something is being detected but has not yet been detected”.

In addition, in the present specification, “detection” is not used but “sensing” is used for quantitative information not including presence or absence, such as a distance and a temperature. For example, in the present specification, the sensed temperature and the sensed distance may be referred to as a “sensing temperature” and a “sensing distance”.

In addition, in the present specification, sensing performed for parking assistance is divided into sensing for detecting a parking available space and sensing for detecting a traveling available space. The sensing for detecting a parking available space may be rephrased as sensing for identifying a space that is not available for parking. The sensing for detecting the parking available space includes, for example, parking frame sensing and free space sensing. Since the free space sensing detects a road surface region that is not hidden by an obstacle, it may be rephrased as road surface region sensing. In addition, a space where parking is not available may be identified by sensing parts of a parked vehicle such as a license plate.

Moreover, in the present specification, the parking assistance may include a function of performing detection traveling for searching for a parking available space, and whether there is an obstacle in a traveling region may be sensed by free space sensing or obstacle sensing by sonar, and this may be included in sensing performed for parking assistance. In addition, after a parking available space is detected, a region through which the vehicle passes when the vehicle is parked may be detected by free space sensing or obstacle sensing using sonar, and may be included in sensing performed for parking assistance.

The parking assistance ECU 14 combines the information on the position of the vehicle 1 and the information on the obstacle, identifies a space where there is no obstacle around the host vehicle, and determines whether the space is a space where parking is possible. For example, the parking assistance ECU 14 obtains information on the position of the vehicle 1 from a navigation system (not illustrated), and senses a parking frame when the vehicle 1 is located in a parking lot. When detecting a white line from the camera images received from the cameras 14a to 14d, the parking assistance ECU 14 determines whether the white line constitutes a parking frame available for parking.

The parking assistance ECU 14 generates a display image for displaying the surroundings of the vehicle from the camera image to output the display image to the HMI device 15 (for example, a touch panel display or the like). In a case where the parking assistance ECU 14 detects the parking available space or the parking frame, the parking assistance ECU displays the parking position on the display image and requests the driver's consent. When the driver agrees, the parking assistance ECU 14 starts control to move the vehicle 1 to the parking position.

Configuration of Parking Assistance ECU

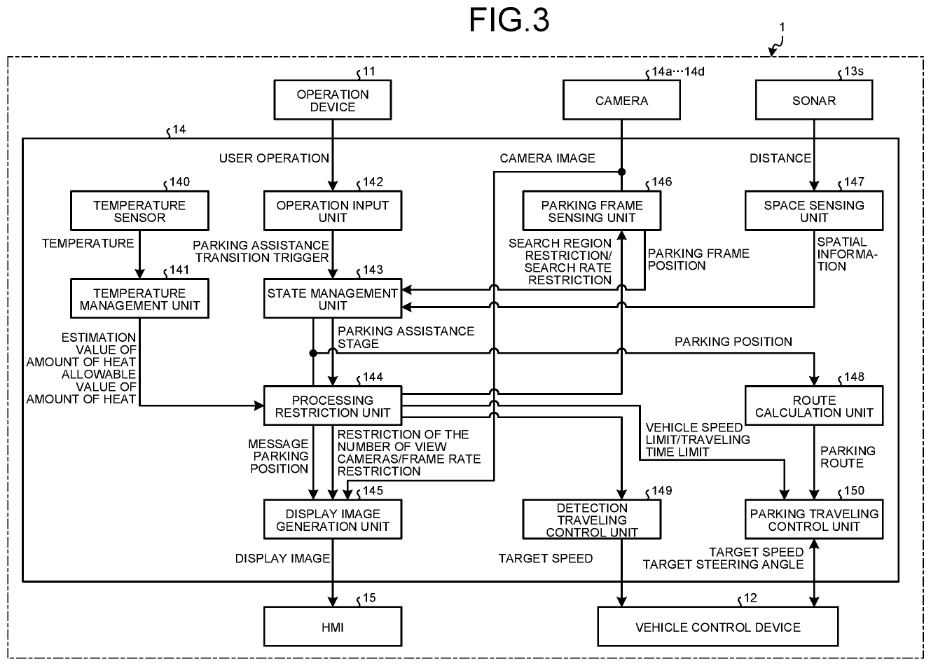

Next, a configuration of the parking assistance ECU 14 will be described. FIG. 3 is a block diagram illustrating an example of a configuration of the parking assistance ECU 14 according to the first embodiment. As illustrated in FIG. 3, the parking assistance ECU 14 includes a temperature sensor 140. The temperature sensor 140 senses an internal temperature (for example, the temperature of the chip that performs the image processing) of the parking assistance ECU 14. The internal temperature of the parking assistance ECU 14 and the temperature of the chip are examples of the temperature of the parking assistance device.

In addition, the parking assistance ECU 14 includes, as function units, a temperature management unit 141, an operation input unit 142, a state management unit 143, a processing restriction unit 144, a display image generation unit 145, a parking frame sensing unit 146, a space sensing unit 147, a route calculation unit 148, a detection traveling control unit 149, and a parking traveling control unit 150.

The parking assistance ECU 14 includes a metal housing having a waterproof structure in order to obtain weather resistance. Therefore, it is known that dynamic cooling such that a desktop computer air-cools a CPU with a fan cannot be performed. Therefore, the cooling unit included in the parking assistance ECU 14 is only a static cooling unit configured to release heat to the retainer of the vehicle body of the vehicle 1 via the housing by heat conduction.

Most of the functions of the parking assistance system 10, particularly, the display image generation unit 145 and the parking frame sensing unit 146 that handle images are realized by one or more image processing processors. In the present embodiment, the parking assistance ECU 14 has a general configuration in which the above-described image processing processor group and a microcomputer (microcontroller) that controls the image processing processor group are integrated in one chip.

In such a highly integrated chip, when all the processors are continuously operated at the upper limit of the processing performance, the chip may be physically self-destructed (the chip may be broken or disconnected) at a high temperature. Therefore, in the present embodiment, the temperature sensor 140 is installed in a chip in which image processing processor is integrated, and thereby the internal temperature of the parking assistance ECU 14 can be monitored. The temperature of the chip is the highest in the parking assistance ECU 14 when the chip in which the image processing processors are integrated are fully operated. Therefore, it is necessary and effective to monitor the temperature of the chip. While the temperature inside the parking assistance ECU 14 varies with the part, it is reasonable to consider the temperature of the chip in which the image processing processors having the highest temperature are integrated as the internal temperature of the parking assistance ECU 14 in order to avoid self-destruction.

Note that one temperature sensor 140 may be provided, but it is preferable that a plurality of temperature sensors is provided. For example, when the temperature of the housing (point A) in contact with the retainer of the vehicle body is sensed, it can be said that the temperature is close to the external temperature. When the chip performs a predetermined process and the temperature of the chip and the temperature of the point A reach a steady state, the temperature difference between the two points is expressed by “the thermal resistance between the two points×the amount of heat generated”.

Since the thermal resistance is constant, the temperature difference is proportional to the amount of heat generated. In the case of the image processing, the content of the image may slightly affect the amount of heat generated, but the amount of heat generated is approximately proportional to the number of pixels processed per unit time. Therefore, in a case where the thermal resistance is known, the temperature difference generated by the image processing is predicted, and, for example, the temperature of the chip is predicted from “the temperature of the chip=the temperature of the point A+the temperature difference”. It is possible to determine whether the temperature exceeds the guaranteed operating temperature.

The temperature management unit 141 performs processing including the prediction of the temperature rise as described above in accordance with the temperature. The temperature management unit 141 is an example of a temperature management unit. Details of the temperature management unit 141 will be described later.

The operation input unit 142 receives operation information related to an operation (user operation) of the vehicle 1. As described above, the operation device 11 includes an operation device for driving, such as a steering wheel, a pedal, or a gear, in addition to a physical switch on a panel of the driver's seat or a soft switch displayed on a touch panel. An operation device for driving such as a steering wheel, a pedal, and a gear is monitored by the vehicle control device 12.

Therefore, the operation input unit 142 receives operation information about operation for driving from the operation device 11 via the LAN 16. Additionally, since the touch panel is often shared with the navigation system, the operation input unit 142 monitors a switch provided on a panel of the driver's seat and receives operation information about the touch panel of the navigation system.

The state management unit 143 manages a state of parking assistance (parking assistance stage). The initial state is a state in which parking assistance is not performed (Stage 0). When the driver instructs to start parking assistance with the operation device 11, the operation input unit 142 receives an operation to output operation information to the state management unit 143. When there is operation information for instructing to start parking assistance, the state management unit 143 starts detection traveling (Stage 1).

The detection traveling is traveling for detecting a place where parking is possible. During the detection traveling, the detection traveling control unit 149 described later outputs a control command including a target speed. The vehicle control device 12 controls the vehicle speed to follow the target speed in accordance with the control command. During the detection traveling, the vehicle speed is automatically controlled by the vehicle control device 12, but since the steering angle is a manual operation, the driver may operate the steering wheel so as to run the vehicle along the passage in the parking lot.

In addition, when a vacant parking frame is detected by a parking frame sensing unit 146 to be described later during detection traveling and the driver instructs parking in the vacant parking frame (parking assistance transition trigger), the route calculation unit 148 to be described later calculates a parking route to a target parking position. At this time, the state management unit 143 advances the parking assistance state to the Stage 1.5.

After the calculation of the parking route, the state management unit 143 advances the parking assistance state to the Stage 2. In the Stage 2, the parking traveling control unit 150 described later outputs a control command including a target speed and a target steering angle. The vehicle control device 12 controls the vehicle 1 such that the vehicle speed and the steering angle follow their respective target values in accordance with the control command. In the present embodiment, the parking route calculation is a process in the Stage 1.5 in distinction from the Stage 1 and the Stage 2, but the parking route calculation may be included in the Stage 2.

Note that there is also known simple automatic parking in which a driver finds a vacant parking frame, performs a manual operation until the vehicle 1 is put sideways at the vacant parking frame (Stage 1), performs parking frame sensing and parking route calculation in a stopped state (Stage 1.5), and performs only parking traveling (Stage 2) by automatic driving. Such automatic parking that does not include detection traveling may also be referred to as automatic parking (narrow sense), but in the present specification, automatic parking refers to automatic parking in a broad sense including detection traveling unless otherwise specified.

Meanwhile, in a general parking lot, the passage is often set to be narrow in order to increase the number of parked vehicles per unit area. Therefore, the vehicle 1 may be configured to be able to sense a parking frame up to a distance of, for example, about twice the vehicle length in the lateral direction from the vehicle 1. This is because, when the vehicle 1 travels in the center of the passage, the entire parking frames left and right of the passage often fall within the range where the parking frame can be sensed.

Parking frame lines (for example, a pair of white lines indicating a long side of a parking frame) constituting one parking frame when viewed from a vehicle on a passage are partially hidden by a vehicle body of a parked vehicle when there is a vehicle parked at the position (hereinafter, also referred to as a parked vehicle). Therefore, by determining that “the parking frame has been detected” on condition that a pair of complete white lines (for example, a white line having a length of 1.8 m or more and not suspended in the middle) has been detected from the captured image of the in-vehicle camera, a case where the parking frame has been detected corresponds to a case where a vacant parking frame has been detected.

The processing restriction unit 144 restricts the image processing performed by the parking assistance ECU 14. The processing restriction unit 144 is an example of a processing restriction unit.

Note that, in the present specification, “restricting the image processing” includes any of restricting the range of the input image or the number of input pixels in the display image generation and the sensing process, restricting the execution interval in the display image generation and the sensing process, performing the sensing process in association with the position of the vehicle 1 and not performing the sensing process at a position other than a specific position, not performing the sensing process by the image processing while the sonar sensor senses the parking available space, or performing the sensing process by the image processing when the sonar sensor detects the parking available space.

For example, the processing restriction unit 144 restricts the image processing performed by the display image generation unit 145 and the parking frame sensing unit 146 described later in accordance with the information output by the temperature management unit 141 and the stage managed by the state management unit 143. Details of the processing restriction unit 144 will be described later.

The display image generation unit 145 receives the camera images from the cameras 14a to 14d. The display image generation unit 145 is an example of an image input unit. In addition, the display image generation unit 145 generates a display image on the basis of the camera image. It can be said that the display image generation unit 145 performs image processing with a camera image as an input because it generates the display image with a camera image as an input. Therefore, the display image generation unit 145 is also an example of image processing unit.

The display image may be a panoramic image overlooking the traveling direction to the left and right, or may be a bird's-eye view image overlooking the surroundings of the vehicle from above. In addition, the display image generation unit 145 may display a message in a superimposed manner on the display image in response to a request from the state management unit 143.

The parking frame sensing unit 146 analyzes the camera image and senses the white line. Since the parking frames are provided left and right of the passage, the white line is sensed from the camera images captured by the left and right cameras. More precisely, a sensing image is generated on the basis of the camera image, and the sensing image is analyzed to sense the white line. The sensing image is a bird's-eye view image generally called a top view, and is obtained by converting only a portion to be subjected to parking frame sensing into a bird's-eye view image. Each of the cameras 14a to 14d includes a fisheye lens. Therefore, a pair of white lines (long sides of the parking frame) constituting the parking frame is not necessarily reflected as a straight line because a distance between the lines is narrower as the distance from the vehicle increases on the camera image. However, since lens distortion is corrected at the time of conversion into a bird's-eye view image, the white lines appear as parallel straight lines on the bird's-eye view image. That is, the parking frame sensing process generates a sensing image on the basis of the camera image, and analyzes whether there is a pair of parallel white lines in the sensing image. The parking frame sensing unit 146 further determines whether the detected white lines constitute a parking frame available for parking.

It can be said that the parking frame sensing unit 146 receives the camera images from the cameras 14a to 14d and analyzes the camera images. Therefore, the parking frame sensing unit 146 is an example of an image input unit. In addition, it can be said that the parking frame sensing unit 146 senses the situation around the vehicle on the basis of the camera image. Therefore, the parking frame sensing unit 146 is also an example of a sensing unit.

In addition, since the process for generating the sensing image from the camera image and the process for sensing the situation around the vehicle on the basis of the sensing image is included in the image processing, it can be said that the parking frame sensing unit 146 performs the image processing with a camera image as an input. Therefore, the parking frame sensing unit 146 is also an example of image processing unit.

Note that the parking frame sensing unit 146 may perform processing of sensing the situation around the vehicle on the basis of the display image generated by the display image generation unit 145. For example, when the display image is a bird's-eye view image, the display image can also be used as a sensing image. In this case, the display image generated by the display image generation unit 145 is an example of the sensing image generated with a camera image as an input.

When the parking frame sensing unit 146 senses a parking frame, it may be said that a vacant parking frame available for parking is sensed. This is because, for example, in a case where the parking frame includes a pair of white lines, when there is no parked vehicle parked in the parking frame, the pair of entire white lines appears in one camera image, but when there is a parked vehicle parked in the parking frame, the pair of entire white lines does not appear in one camera image.

Therefore, when a complete parking frame (the distance between two parallel white lines is 2.0 m to 2.5 m, and the length of each white line is 1.8 m or more.) is detected, it may be said that a vacant parking frame is detected. When the vacant parking frame is detected, the parking frame sensing unit 146 notifies the state management unit 143 of detection of the parking frame and the position of the parking frame.

The space sensing unit 147 analyzes distance information obtained by the side sonars (FRS, FLS, BRS, BLS) each sensing the side of the passage to sense a parking available space. The space sensing unit 147 is an example of a space sensing unit. The parking available space is an example of a space that satisfies a predetermined condition. For example, in a case where a state in which the side sonar FRS does not detect an obstacle within 2.5 m continues while the vehicle 1 moves forward by 1.8 m, the space sensing unit 147 can determine that there is a parking available space right side of the vehicle 1.

Note that, since there is a case where the directivity of the sound wave is low and the sound wave flying in an oblique direction from the sonar is reflected by the vehicle parked in the adjacent frame and returns, even when there is a space in which one vehicle can be parked, a state in which no obstacle is detected within 2.5 m may continue only while the vehicle 1 travels about 1.0 m. Therefore, the threshold value for determining that there is a parking available space may be determined on the basis of the directivity of the sonar sensor or the like. Sensing information other than the distance information obtained from the sonar may be used for space sensing. The information other than the distance information is, for example, information on the intensity of the reflected wave. Due to the directivity of the ultrasonic wave, the intensity of the reflected wave of the sound wave flying from the sonar in the oblique direction is lower than the intensity of the reflected wave of the sound wave flying frontward. Therefore, it may be determined that it is not the reflected wave from frontward of the sonar by evaluating the intensity.

It can be said that the space sensing unit 147 receives the sensing information including the distance information sensed by the sonar sensor and senses the space by analyzing the distance information. The distance information sensed by the sonar sensor is an example of the sensing information. Therefore, the space sensing unit 147 is an example of a sensing information input unit.

Both the parking frame sensing unit 146 and the space sensing unit 147 sense a parking available place. However, when the sensing results of the parking frame sensing unit 146 and the space sensing unit 147 are different, the state management unit 143 gives priority to the sensing result of the parking frame sensing unit 146.

For example, when the parking frame sensing unit 146 has not detected a vacant parking frame, even when the space sensing unit 147 has detected a parking available space, the state management unit 143 does not determine that the parking available space has been detected. This is because the parking frame sensing unit 146 has higher determination reliability.

For example, the space sensing unit 147 may also detect a pedestrian passage or a cart place provided in a parking lot as a parking available space. Therefore, it can be said that the reliability of the space sensing unit 147 is lower than that of the parking frame sensing unit 146. Therefore, it may not be determined that the parking available place has been detected only when the parking frame sensing unit 146 does not detect the white line. Conversely, when the parking frame sensing unit 146 detects a vacant parking frame but the space sensing unit 147 does not detect a parking available space, the state management unit 143 may not determine that an available parking place has been detected. This is because, for example, when a two-wheeled vehicle is parked at the center of a parking frame, two white lines indicating long sides of the parking frame are detected, but parking cannot be performed.

For example, when at least one of the parking frame sensing unit 146 and the space sensing unit 147 detects a parking available space, the state management unit 143 may determine that a parking available place has been detected. When the parking available place is detected, the state management unit 143 displays the target parking position in the display image output by the display image generation unit 145. When the parking frame sensing unit 146 detects a vacant parking frame, the target parking position is displayed at a position overlapping with the parking frame in the display image. In addition, when there is no detection of the white line by the parking frame sensing unit 146 and the space sensing unit 147 detects a parking available space, the state management unit 143 may set the target parking position in a region that is near the center of the space and that is not the passage.

When an obstacle is detected near the vacant parking frame, the state management unit 143 may correct the target parking position in accordance with the position of the obstacle. Additionally, after displaying the target parking position, the state management unit 143 may receive a correction operation of the target parking position from the driver via the HMI device 15 (for example, the touch panel). Note that it is very important to receive an operation of agreeing to parking at the target parking position regardless of the presence or absence of the correction operation. For example, even when one or both of the parking frame sensing unit 146 and the space sensing unit 147 erroneously detect the parking available space, it is possible to prevent an accident by starting parking traveling with the driver's consent. At this time, in order to avoid an erroneous recognition and an erroneous operation, the consent may be received by a dedicated hardware switch instead of the switch displayed on the touch panel.

When the driver performs an operation to agree to park at the target parking position, the state management unit 143 determines the target parking position displayed on the HMI device 15 as the final target parking position.

The route calculation unit 148 calculates a parking route for moving the vehicle 1 to the determined target parking position. Note that an existing technique can be used for the parking route calculation.

The detection traveling control unit 149 controls the vehicle 1 via the vehicle control device 12 during the detection traveling. For example, the detection traveling control unit 149 generates a control command such that the vehicle speed during the detection traveling is the target speed to output the control command to the vehicle control device 12. The detection traveling control unit 149 is an example of a parking assistance control unit.

The parking traveling control unit 150 controls the vehicle 1 via the vehicle control device 12 during parking traveling. The parking traveling control unit 150 generates a control command for controlling the steering angle and the vehicle speed such that the vehicle 1 travels along the calculated parking route to output the control command to the vehicle control device 12. The parking traveling control unit 150 is an example of a parking assistance control unit.

More specifically, the parking traveling control unit 150 outputs a control command including target values of the steering angle and the vehicle speed to the vehicle control device 12, and the vehicle control device 12 controls the steering device and the drive device of the vehicle 1 such that the steering angle and the vehicle speed of the vehicle 1 match the target values, and simultaneously outputs actual measurement values of the steering angle and the vehicle speed obtained from the steering device and the drive device to the parking traveling control unit 150.

When there is a difference between the target value and the actual measurement value and the calculated parking route and the actually traveling route are deviated, the parking traveling control unit 150 corrects the target values of the steering angle and the vehicle speed such that the vehicle 1 returns to the calculated parking route.

In addition, even during parking traveling, the parking frame sensing unit 146 may be caused to perform parking frame sensing, may calculate a deviation between the current position of the vehicle 1 and the planned parking route by collating the position of the parking frame on the calculated parking route with the detected position of the parking frame, and may correct the target values of the steering angle and the vehicle speed. Note that a path through which the parking traveling control unit 150 receives the parking frame information from the parking frame sensing unit 146 in this case is not illustrated.

Note that the detection traveling control unit 149 is different from the parking traveling control unit 150 only in not controlling the steering angle, and thus a detailed description thereof will be omitted. In the present embodiment, the detection traveling control unit 149 and the parking traveling control unit 150 are different function units. However, their functions are similar. Therefore, the detection traveling control unit and the parking traveling control unit may be integrated, and the operation may be switched in accordance with the stage. For example, the functions of the detection traveling control unit 149 and the parking traveling control unit 150 may be realized by one program described such that only the control of the vehicle speed is performed in the Stage 1, and the control of the vehicle speed and the steering angle is performed in the Stage 2. Alternatively, when both the steering angle and the vehicle speed are automatically controlled even in the detection traveling, it is not necessary to separate the detection traveling control unit 149 and the parking traveling control unit 150, and thus they may be collectively the automatic traveling control unit.

Under the control of the parking traveling control unit 150, the parking traveling control unit 150 stops the vehicle 1 when the vehicle 1 reaches the end point of the parking route, that is, the target parking position. In addition, the state management unit 143 displays a message of parking completion on the display image generation unit 145 to complete parking assistance.

Processing Performed by Temperature Management Unit

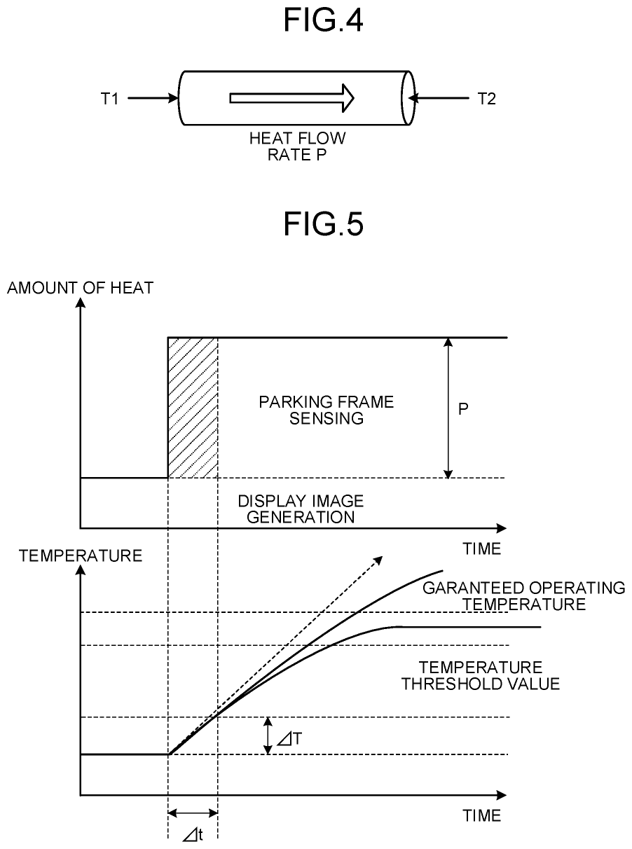

Hereinafter, the processing performed by the temperature management unit 141 will be described with reference to FIG. 4 and FIG. 5. As a premise, in the present embodiment, the amount of energy generated or transferred per unit time corresponding to the wattage (W=J/S, where J denotes Joule and s denotes second) is referred to as an amount of heat. In addition, the total amount of energy generated or transferred within a specific period corresponding to watt-hours or joules is referred to as a total amount of heat.

Note that, in general, the amount of heat refers to the total amount of energy (the number of joules). When the total amount of energy is referred to as the amount of heat, it is necessary to preface “per unit time” each time when describing the amount of heat generated, which is troublesome.

The present embodiment describes the control of the ECU operated by electricity, and related service providers and the like may conventionally call the wattage as the amount of heat generated or simply the amount of heat. Therefore, in the present embodiment, as a simple expression, the wattage is referred to as the amount of heat, and a power product (watt-hour number) obtained by multiplying the wattage by time is referred to as a total amount of heat.

According to this expression, the amount of energy generated per unit time is referred to as the amount of heat generated or simply the amount of heat. In addition, the amount of energy transferred per unit time is referred to as a heat flow rate or simply the amount of heat.

The temperature management unit 141 controls the amount of heat generated of the chip (that is, the wattage) such that the temperature of the chip does not exceed the guaranteed operating temperature of the chip.

The temperature management unit 141 receives information (sensing result by the temperature sensor 140) on the temperature of the chip from the temperature sensor 140 in order to perform control such that the temperature of the chip does not exceed the guaranteed operating temperature of the chip. That is, it can be said that the temperature management unit 141 senses the temperature of the chip in cooperation with the temperature sensor 140. Therefore, the temperature management unit 141 is an example of a temperature sensing unit. The guaranteed operating temperature of the chip is an example of a temperature limit.

Hereinafter, the amount of heat generated of the chip will be described with reference to FIG. 4. FIG. 4 is a diagram for describing an example of heat generation of the chip. In FIG. 4, the amount of heat generated of the chip is P, the internal temperature of the chip is T1, and the temperature of the portion where the parking assistance ECU 14 is in contact with the vehicle body is T2.

T2 reflects the temperature of the vehicle body of the vehicle 1, and since the vehicle body is outside for the parking assistance ECU, T2 is referred to as an external temperature. Assuming that there is no change in temperature of T1 and T2 in the steady state, it can be said that the amount of heat generated is in the steady state by being balanced with the heat flow rate flowing through the vehicle body. That is, in a steady state (thermal equilibrium state), “amount of heat generated=heat flow rate”.

As in Ohm's law (V1−V2=r×I), the heat flow rate generates a temperature difference proportional to the thermal resistance Rth, and Rth×heat flow rate P=T1−T2. The thermal resistance Rth is determined by a joint state between the structure of the parking assistance ECU 14 and the vehicle body. Therefore, the thermal resistance Rth can be set to a known value by calculation based on the structure and theory or calculation based on an actual measurement value.

In addition, assuming that the temperature difference at the time when the chip reaches the guaranteed operating temperature is ΔTmax, ΔTmax is expressed by “the guaranteed operating temperature of the chip−T2”. In a case where the amount of heat when the chip reaches the guaranteed operating temperature is defined as a limit amount of heat: Pmax, Pmax=ΔTmax/Rth, and the guaranteed operating temperature is a constant. Therefore, in a case where Rth is known, Pmax can be calculated from T2. That is, the allowable limit amount of heat: Pmax is determined by the temperature T2 of the vehicle body.

In addition, the amount of heat generated by the chip is generally proportional to the number of pixels to be processed. When the amount of heat generated by the chip is P and the number of pixels processed per unit time is S, P≈A×s+B can be expressed. A is a proportional coefficient, and varies with processing complexity and contents of an image. Therefore, a large value may be applied when estimating the amount of heat. B is the amount of heat generated by a steady process called a base load. For example, the parking assistance ECU 14 processes the camera image to generate the display image even when the parking frame sensing is not performed. Therefore, the amount of heat for generating the display image corresponds to B (base load).

In the generation of the display image, a still image of 60 frames per second is usually generated, but the execution frequency of the parking frame sensing may be lower. This is because, in a case where the parking frame is not detected even when the camera image is processed to search for the parking frame, there is a low possibility that the parking frame can be detected even if the camera image after 1/60 seconds is processed. When the execution frequency of the parking frame sensing is reduced, the number of pixels S to be processed per unit time is reduced. Therefore, the amount of heat generated P≈A×S by the parking frame sensing is also reduced.

In addition, since the limit amount of heat: Pmax is determined in accordance with the external temperature T2, and Pmax decreases when T2 is high, the temperature management unit 141 may perform control to decrease the execution frequency of the parking frame sensing when the external temperature T2 is high.

FIG. 5 is a diagram for describing an example of the relationship between the processing performed by the parking assistance ECU 14 and the temperature of the chip. As illustrated in FIG. 5, when the display image generation is performed as the base load and the temperature is in a steady state, the temperature rises when the amount of heat generated P by the parking frame sensing is applied. When the temperature increases by ΔT during the first Δt, ΔT=P×Δt/Cth (where Cth denotes a heat capacity) can be expressed.

The heat capacity Cth may be calculated from the amount and specific heat of the chip and the material around the chip, or may be calculated from an observation value by observing the temperature rise width with respect to the amount of heat generated. When the heat capacity Cth is known as described above, the rate of increase in temperature=ΔT/Δt can be calculated from the amount of heat generated P of the chip.

In addition, it is also possible to calculate the time until the temperature of the chip reaches the guaranteed operating temperature when the rate of increase in temperature continues. In practice, since the heat flow rate increases as the temperature of the chip increases, the rate of increase in temperature gradually decreases. Since the rate of decrease in the rate of increase depends on the thermal resistance Rth, the temperature management unit 141 may more accurately predict the time until the temperature of the chip reaches the guaranteed operating temperature in addition to the calculation of the thermal resistance Rth.

When the amount of heat generated P of the chip is equal to or less than the above-described limit amount of heat: Pmax, the temperature of the chip is saturated without exceeding the guaranteed operating temperature, and thus the temperature management unit 141 does not need to restrict the process for sensing a parking frame. On the other hand, in a case where the amount of heat generated P of the chip exceeds the limit amount of heat: Pmax, there is a possibility that the temperature of the chip exceeds the guaranteed operating temperature, and thus, the temperature management unit 141 restricts the process for sensing the parking frame.

For example, the temperature management unit 141 may reduce the execution frequency of the parking frame sensing to satisfy P<Pmax. In addition, the temperature management unit 141 may calculate the time margin: Tmax until the temperature of the chip exceeds the guaranteed operating temperature, and may decrease the execution frequency of the parking frame sensing, for example, when the time from the start of the parking frame sensing exceeds a time threshold value (for example, 70% of Tmax), and may not decrease the execution frequency of the parking frame sensing while the time is less than the time threshold value.

For example, when the parking lot is not almost full, there is a high probability that a vacant parking frame can be found in a short time. Therefore, it is possible to obtain a better sense of use when the parking frame sensing is not restricted at first than when the parking frame sensing is restricted at first. In addition, in a state where the parking lot is almost full, the inside of the parking lot is often congested, and thus, it is considered that there is no substantial disadvantage even when the execution frequency of the parking frame sensing is reduced. Note that a temperature threshold value may be provided instead of the time threshold value, and the parking frame sensing may be restricted when the temperature threshold value is exceeded.

However, in this case, depending on the setting of the temperature threshold value, saturation may occur without exceeding the guaranteed operating temperature even when the temperature threshold value is exceeded. Therefore, it is preferable to set the temperature threshold value so as not to unnecessarily restrict the function.

It can be said that the process for setting the time threshold value or the temperature threshold value and restricting the parking frame sensing when the time threshold value or the temperature threshold value is exceeded as described above is processing of predicting the change in temperature of the chip and restricting the parking frame sensing in response to determining that the temperature of the chip exceeds the guaranteed operating temperature.

Therefore, it can be said that the temperature management unit 141 predicts a change in the temperature of the parking assistance device on the basis of the temperature of the parking assistance device, and performs processing of increasing the degree of the restriction in response to determining that the prediction value of the temperature of the parking assistance device exceeds the predetermined temperature limit, in comparison with the degree of the restriction to be applied in response to determining that the prediction value of the temperature of the parking assistance device does not exceed the predetermined temperature limit.

Control for Suppressing Heat Generation of Parking Assistance ECU

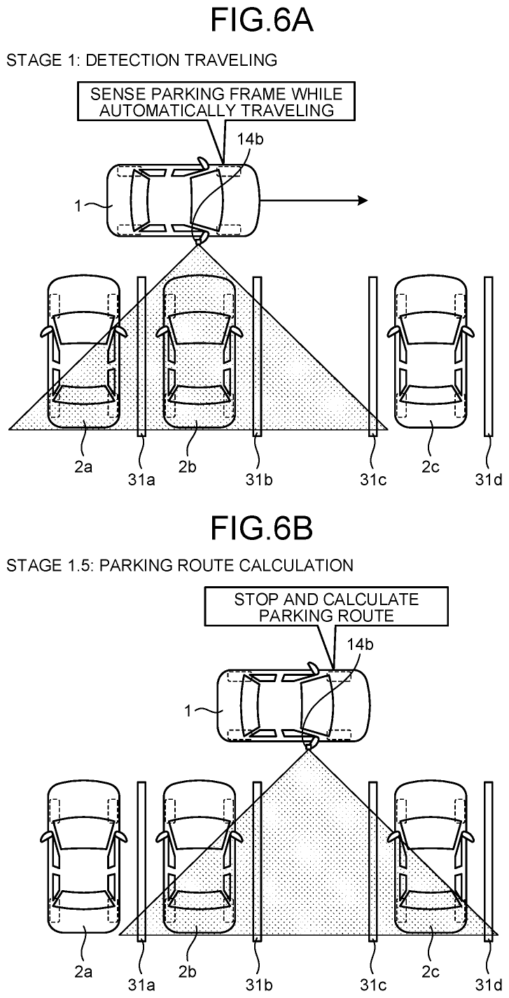

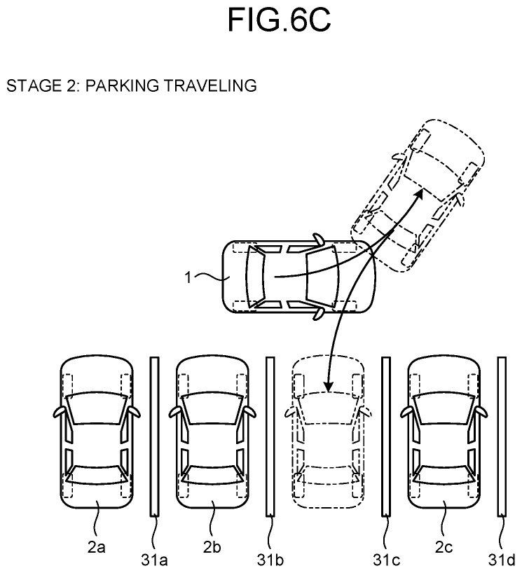

Next, control for suppressing heat generation of the parking assistance ECU will be described with reference to FIGS. 6 to 13. First, the relationship between the parking assistance stage and the control for suppressing heat generation will be described. FIG. 6A is a diagram for describing an example of the detection traveling (Stage 1).

As illustrated in FIG. 6A, when the detection traveling of the Stage 1 is performed, the vehicle 1 detects parked vehicles 2a to 2c, the white lines 31a to 31d, and the like using, for example, the camera 14b while automatically traveling in the parking lot at the target speed, thereby detecting the vacant parking frame. In the detection traveling of the Stage 1, the vehicle 1 continues the parking frame sensing process until a vacant parking frame is detected. For this reason, the upper limit of the processing time cannot be defined for the detection traveling.

For example, in a parking lot that is close to full, the passage is likely to be congested. Therefore, even when the vehicle prowls in the parking lot for nearly 10 minutes, the vehicle may not encounter a vacant parking frame. When the temperature of the chip (image processing LSI) reaches the guaranteed operating temperature during the detection traveling, automatic parking (detection traveling) has to be stopped. Therefore, the processing restriction unit 144 performs control for suppressing heat generation of the parking assistance ECU 14 at the time of detection traveling on the basis of the prediction and determination by the temperature management unit 141. In addition, as described above, the processing restriction unit 144 may divide the stage of the detection traveling before and after the time threshold value or the temperature threshold value is exceeded, and perform control for suppressing the heat generation in accordance with the stage. For example, when the temperature of the parking assistance ECU 14 exceeds a predetermined temperature threshold value, the stage may be raised to the detection traveling Stage 1.2, and the control for suppressing heat generation in the Stage 1.2 may be made stronger than in the Stage 1 for the detection traveling.

FIG. 6B is a diagram for describing an example of the parking route calculation (in the Stage 1.5). As illustrated in FIG. 6B, when a vacant parking frame is detected by the parking frame sensing unit 146 to be described later during detection traveling and a driver instructs parking in the vacant parking frame, the vehicle 1 stops and calculates a parking route. The parking route calculation is a process with high complexity, but is not the image processing, and thus the number of calculations is relatively small. In addition, since the parking route calculation of the Stage 1.5 is generally completed in about several seconds, the power product obtained by multiplying the amount of heat generated by time is small. Therefore, there is little need for control for suppressing heat generation of the parking assistance ECU 14.

FIG. 6C is a diagram for describing an example of the parking traveling (Stage 2). As illustrated in FIG. 6C, when the parking traveling of the Stage 2 is performed, the vehicle 1 automatically travels along the calculated parking route until reaching the target parking position.

Since the parking traveling of the Stage 2 ends in several tens of seconds, necessity of control for suppressing heat generation of the parking assistance ECU 14 is smaller than that of the detection traveling. However, it is conceivable that the temperature of the parking assistance ECU 14 increases during the detection traveling of the Stage 1 and the execution of the parking route calculation of the Stage 1.5. Therefore, it can be said that it is better to perform control for suppressing heat generation of the parking assistance ECU 14 even during parking traveling. Therefore, in the present embodiment, control for suppressing heat generation of the parking assistance ECU 14 is performed at a stage where detection traveling or parking traveling is performed.

It can be said that the necessity of the control for suppressing the heat generation of the parking assistance ECU 14 performed at the time of the detection traveling is higher than that of the control for suppressing the heat generation of the parking assistance ECU 14 performed at the time of the parking traveling. Therefore, in the present embodiment, the processing restriction unit 144 performs a stronger restriction at the time of detection traveling. For example, it may be said that the processing restriction unit 144 of the present embodiment restricts the image processing on the basis of the stage, and performs processing of increasing the degree of the restriction to be applied to the stage of the detection traveling, in comparison with the degree of the restriction to be applied to the stage of the parking traveling.

In the present embodiment, the sonar system 13s is used for the purpose of suppressing heat generation of the parking assistance ECU 14. Since the sonar ECU 13 uses the information on the distance to the obstacle sensed by the sonar sensor, that is, one-dimensional information, it has the smaller amount of heat generated than the parking assistance ECU 14 that processes a two-dimensional image. Therefore, even when the sonar ECU 13 is continuously used for a long time, the sonar ECU does not become inoperable due to a temperature rise.

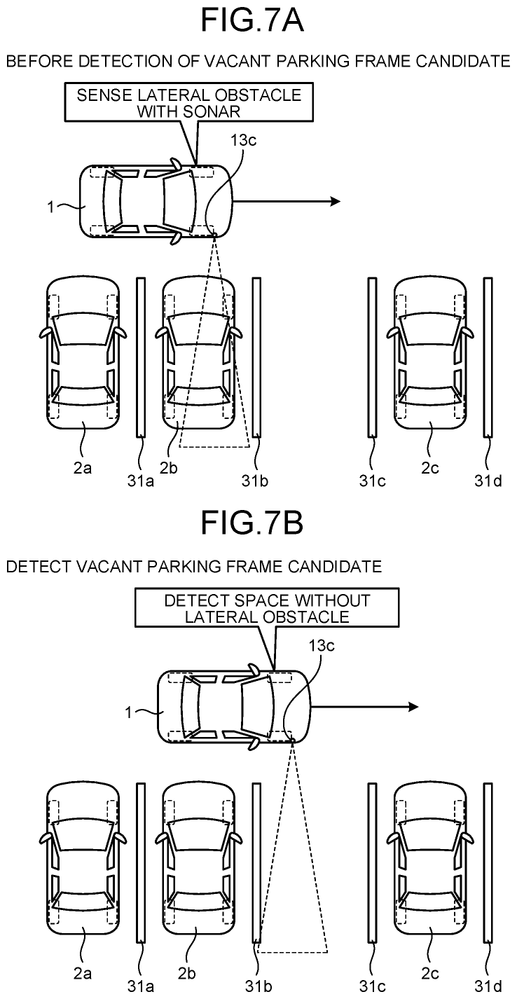

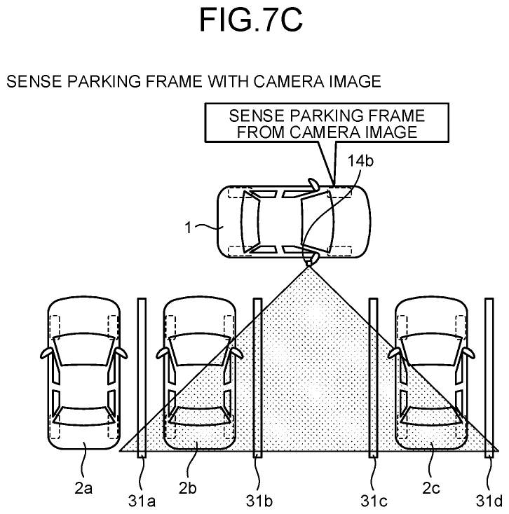

Hereinafter, detection traveling using the sonar system 13s will be described with reference to FIGS. 7A to 7C. FIGS. 7A to 7C are diagrams for explaining an example of detection traveling using the side sonar. In FIGS. 7A to 7C, a case where the vehicle 1 performs detection traveling while sensing a lateral obstacle with the sonar sensor 13c (side sonar FRS) will be described as an example.

As illustrated in FIG. 7A, when the sonar sensor 13c detects an obstacle (for example, the parked vehicle 2a and/or the parked vehicle 2b) at a short distance (for example, within 1.5 m), it can be determined that “there is no vacant parking frame in the direction in which the sonar sensor 13c is directed”. In such a situation, the parking frame sensing for processing the camera image may be stopped.

As illustrated in FIG. 7B, when no obstacle is detected in a short distance continues for a given distance or more, the parking frame sensing unit 146 determines that a space satisfying a predetermined condition has been detected. Since the predetermined condition is that the space has a width and a depth enough to set the target parking position, the space satisfying the predetermined condition may be referred to as, for example, a vacant parking frame candidate. However, the vacant parking frame candidate may be a pedestrian passage or a parking prohibited region. Therefore, as illustrated in FIG. 7C, in response to determining that a vacant parking frame candidate has been detected, the parking frame sensing unit 146 performs the image processing of detecting a parking frame (for example, white lines 31b and 31c) from a range corresponding to a space satisfying a predetermined condition in the camera image. As a result, when the parking frame is detected in the space satisfying the predetermined condition, determination is made such that the vacant parking frame is detected, and the target parking position is set in the vacant parking frame. Alternatively, while the detection traveling is performed while the sensing is performed by the sonar sensor, the parking frame sensing unit 146 may intermittently perform the white line sensing at a low frequency. In a case where even part of the white line is not sensed, determination may be made such that the parking lot is a parking lot with no indication of a parking frame. In a case where the parking lot is determined as being a parking lot with no indication of a parking frame, even when a parking frame is not detected in a space satisfying a predetermined condition, determination may be made such that a parking available space has been detected, and the target parking position may be set in the space satisfying the predetermined condition.

In this way, when the image processing of the parking frame sensing is performed only when the vacant parking frame candidate is detected by the sonar sensor, or the white line sensing is performed at low frequency, the number of times of performing the image processing of the parking frame sensing is reduced. Therefore, the heat generation of the parking assistance ECU 14 can be suppressed. In addition, by restricting the range where the image processing of the parking frame sensing is performed to a space satisfying a predetermined condition, the amount of the image processing can be reduced.

As described above, performing the process for performing the image processing of the parking frame sensing only when the space satisfying the predetermined condition is detected by the sonar sensor corresponds to stopping the image processing of sensing the parking available space when the space satisfying the predetermined condition is sensed on the basis of the sensing information, and performing the image processing of sensing the parking available space for the space satisfying the predetermined condition when the space satisfying the predetermined condition is detected on the basis of the sensing information.

The sensing of the space satisfying the predetermined condition is not limited to the method using the side sonar (FRS, FLS, BRS, and BLS), and the corner sonar (FLC and FRC) may be used. Since there are relatively few vehicles equipped with side sonars, whereas vehicles equipped with corner sonars are common, the use of corner sonars enables implementation in more vehicles. However, since the side sonar can only sense that there is a space in the frontage portion of the parking frame, the space is not always available for parking. Therefore, the space that satisfies the predetermined condition in the case of using the corner sonar is not referred to as a vacant parking frame candidate, but is referred to as a candidate region that may be available for parking.

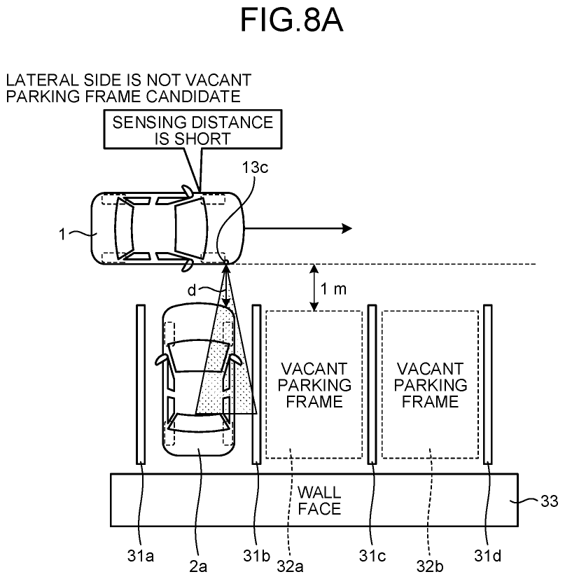

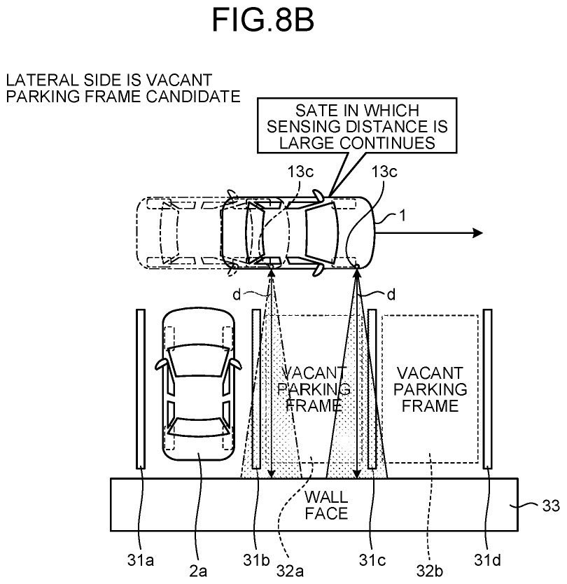

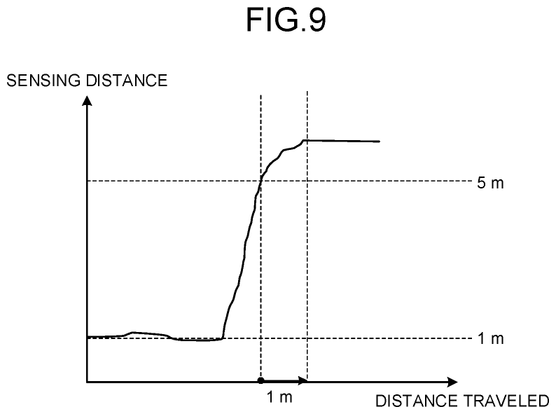

Hereinafter, the process for sensing a space satisfying a predetermined condition by the side sonar will be described with reference to FIGS. 8A and 8B and FIG. 9. FIGS. 8A and 8B are diagrams for describing an example of processing of sensing a parking frame candidate by the side sonar. FIG. 9 is a diagram illustrating an example of a relationship between a distance traveled by the vehicle 1 and a sensing distance by the side sonar. In FIGS. 8A and 8B and FIG. 9, a case where the vehicle 1 performs the process for sensing the space satisfying a predetermined condition by the sonar sensor 13c will be described as an example.

The side sonar transmits a sound wave side of the vehicle 1, and identifies a distance (sensing distance d) to an obstacle by a time until the reflected wave returns. The vehicle 1 measures a distance to a lateral obstacle while traveling a given distance (for example, 1.0 m) away from a region where a parking frame is present. As illustrated in FIG. 8A, when the parked vehicle 2a is present on the side, the sensing distance d is about 1.0 m. Therefore, the space sensing unit 147 can determine that the side is not a vacant parking frame.

In addition, as illustrated in FIG. 8B, when there is no parked vehicle 2a on the side, there is no object between the vehicle 1 and a wall face 33. Therefore, the sensing distance d is 5.0 m or more, or no reflected wave is detected. When the sensing distance d in a case where the reflected wave is not detected is 20 m for the sake of convenience, it is possible to avoid handling the cases separately depending on whether the reflected wave is detected. For example, as illustrated in FIG. 9, in a case where the sensing distance by the sonar sensor 13c is 5.0 m or more while the vehicle 1 travels 1.0 m, the space sensing unit 147 may determine that a parking frame candidate has been detected.

In this way, it is possible to cope with a case where there is no wall or the like behind the parking frame. Note that the exemplified values assume that the parked vehicle is a standard-size car, and may be changed with the size of the parked vehicle. For example, when the parked vehicle is a small vehicle, the vehicle length is 3.8 m, and the vehicle is traveling 0.7 m away from the region with a parking frame, the threshold value of the sensing distance may be 4.5 m (0.7 m+3.8 m).

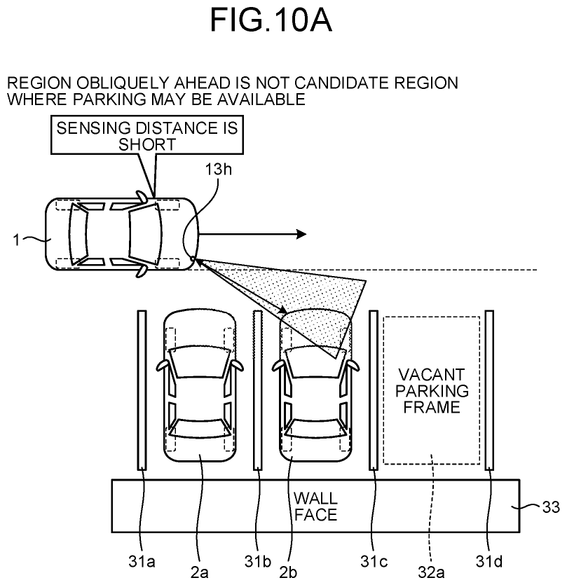

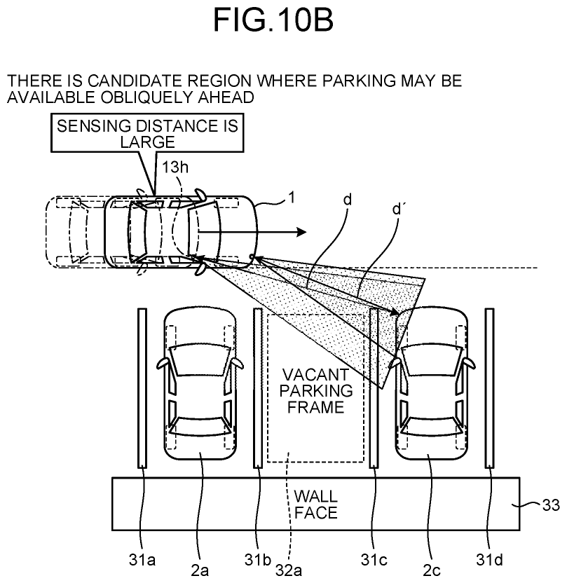

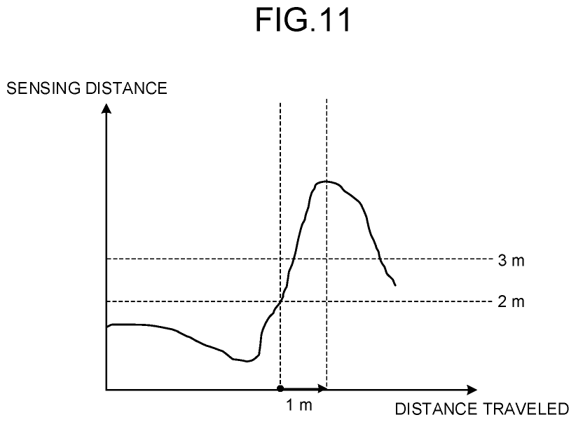

Next, with reference to FIGS. 10 and 11, the process for sensing a candidate region that may be available for parking by the front corner sonar will be described. FIGS. 10A and 10B are diagrams for describing an example of the process for sensing a candidate region that may be available for parking by the front corner sonar. FIG. 11 is a diagram illustrating an example of the relationship between the distance traveled by the vehicle 1 and the sensing distance by the front corner sonar. In FIGS. 10 and 11, a case where the process for sensing a candidate region where the vehicle 1 may be parked by the sonar sensor 13h is performed will be described as an example.

The front corner sonar transmits a sound wave obliquely ahead of the vehicle 1, and identifies a distance (sensing distance) to an obstacle by a time until the reflected wave returns. As illustrated in FIG. 10A, when there is the parked vehicle 2b obliquely ahead, the sensing distance is approximately less than 2.0 m. Therefore, the space sensing unit 147 can determine that the side region is not a candidate region where parking is likely to be available.

As illustrated in FIG. 10B, when there is no parked vehicle obliquely ahead, the sonar sensor 13c senses the distance to the parked vehicle 2c stopped across the parking frame obliquely ahead. In this case, as illustrated in FIG. 11, the sensing distance by the sonar sensor 13c is 3.0 m or more, or the sonar sensor 13c does not detect the reflected wave.

Therefore, for example, the space sensing unit 147 may determine that a candidate region 32a that is likely to be parked obliquely ahead is detected when the sensing distance is 3.0 m or more, or may determine that the candidate region 32a that is likely to be parked obliquely ahead is detected when the sensing distance is 2.0 m or more while the vehicle 1 travels 1.0 m as illustrated in FIG. 11.

When the sonar sensor is disturbed by noise or a sonar wave of another vehicle, the sonar sensor invalidates the sensing result (the sensing distance is set to, for example, 20.0 m). Therefore, it is preferable to add a condition related to the number of times of detection such as time or a movement distance to the condition for determining that the candidate region is detected.

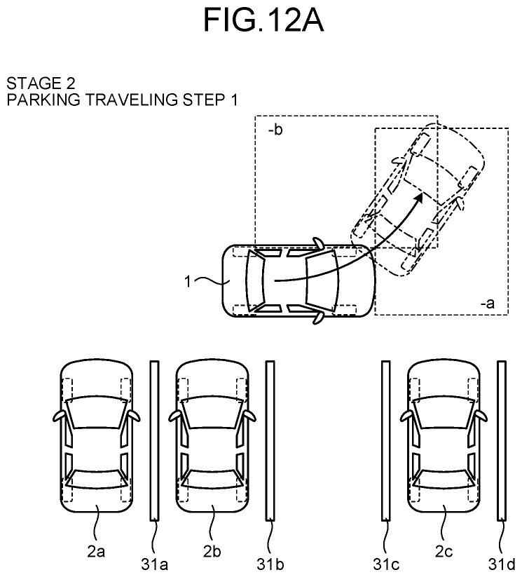

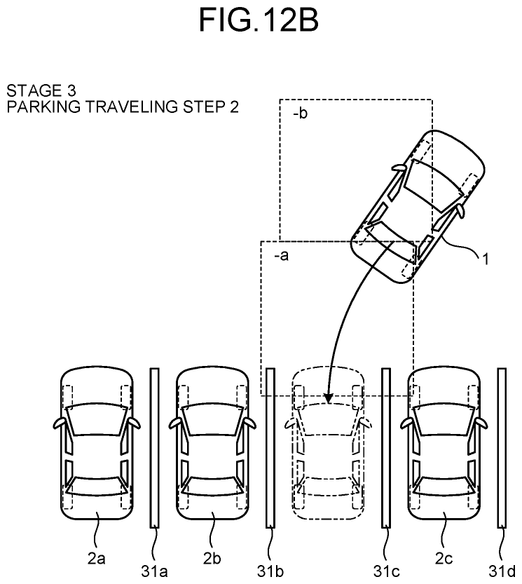

Next, control for suppressing heat generation of the parking assistance ECU 14 related to parking traveling will be described with reference to FIGS. 12A and 12B. FIGS. 12A and 12B are diagrams for describing an example of parking traveling. The parking traveling ends in a relatively shorter time than the detection traveling, but since the parking traveling is performed after the temperature of the chip rises in the detection traveling, the temperature of the chip may reach the guaranteed operating temperature during the parking traveling. Therefore, in the present embodiment, control is performed to suppress heat generation of the parking assistance ECU 14 even during parking traveling.

When the vehicle 1 enters the parking frame in a backward movement manner, the stage of the parking traveling may be divided into a step 1 of moving forward to the turning position and a step 2 of moving backward from the turning position to the target parking position. In addition, a stage after the turning may be set to the Stage 3, and may be separated from a stage before the turning as another stage.

Since the vehicle 1 is deployed at a large steering angle in parking traveling, there is a possibility that the side face of the vehicle 1 is damaged by an obstacle or the side face of the vehicle 1 comes into contact with a pedestrian or another vehicle if detection of the obstacle is missed. Therefore, in the present embodiment, the parking frame sensing unit 146 periodically performs a free space sensing of a range that interferes with the vehicle 1 during parking traveling, and confirms that there is no obstacle.

The free space sensing is processing of evaluating, as a feature amount, a color or luminance of a pixel or a small region including a plurality of pixels, grouping pixels or small regions by determining that pixels or small regions having close feature amounts belong to the same group and pixels or small regions having different feature amounts belong to another group, and identifying positions and sizes of continuous regions belonging to the same group. For example, in a case where the vehicle 1 in FIG. 12A performs a free space sensing using the image of the right side camera as an input, a region between the white line 31b and the white line 31c is detected as a continuous region belonging to the same group.

In addition, the vehicle 1 according to the present embodiment performs the process for sensing the presence or absence of an obstacle by the sonar sensor by the space sensing unit 147 in addition to the process for sensing the presence or absence of an obstacle by the free space sensing. For example, when a continuous region (that is, a road surface region) belonging to the same group as the image (that is, the road surface) appearing near the vehicle body on the image spreads in the traveling direction, the road surface region in the traveling direction can be rephrased as a region without an obstacle. However, the free space sensing is also image processing, and when performed, the temperature of the parking assistance ECU 14 rises. Therefore, the processing amount is limited in accordance with the temperatures of the stage and the chip. In this case, it can be said that the parking frame sensing unit 146 senses the road surface region by the image processing with a camera image as an input. That is, the parking frame sensing unit 146 in this case is an example of a road surface region sensing unit.

As illustrated in FIG. 1, the number of sonar sensors provided on the side face of the vehicle 1 is smaller than the number of sonar sensors provided on the front and back sides. Therefore, for the side of the vehicle 1 (−b in FIGS. 12A and 12B), obstacle sensing may be supplemented by means other than the sonar sensor. For example, in the present embodiment, the parking frame sensing unit 146 performs a free space sensing side of the vehicle 1 (−b in FIGS. 12A and 12B).

On the other hand, since the four sonar sensors are densely disposed in the traveling direction of the vehicle 1 (−a in FIGS. 12A and 12B), there is a low possibility that the obstacle is overlooked even if the free space sensing is not performed. Therefore, for example, when the temperature of the chip is low, both the regions −a and −b may be subjected to the free space sensing, and when the temperature of the chip is high, the region −a ahead of the vehicle may be excluded from a region to be subjected to the free space sensing, and only the lateral region −b may be subjected to the free space sensing. In addition, since the range where the free space sensing is performed varies with the stage, determination whether or not to execute free space sensing may be performed at the transition of the stage.

In addition, for example, in a case where the space sensing unit 147 detects an obstacle in the traveling direction of the vehicle 1, the vehicle 1 is stopped by automatic braking. Therefore, for the traveling direction of the vehicle 1, it is less necessary for the parking frame sensing unit 146 to perform the process for sensing the presence or absence of an obstacle by free space sensing. Therefore, in this case, for the traveling direction of the vehicle 1, the processing restriction unit 144 may stop or restrict (for example, a time interval for performing the process is lengthened) the process for sensing the presence or absence of an obstacle by the free space sensing.

As described above, stopping or restricting the processing for sensing the presence or absence of an obstacle by free space sensing when an obstacle in the traveling direction of the vehicle 1 is detected by the sonar sensor corresponds to making a degree of the restriction of the road surface region sensing by the image processing stronger when an obstacle on the path of the vehicle 1 is being sensed on the basis of the sensing information than when an obstacle on the path is not being sensed on the basis of the sensing information.

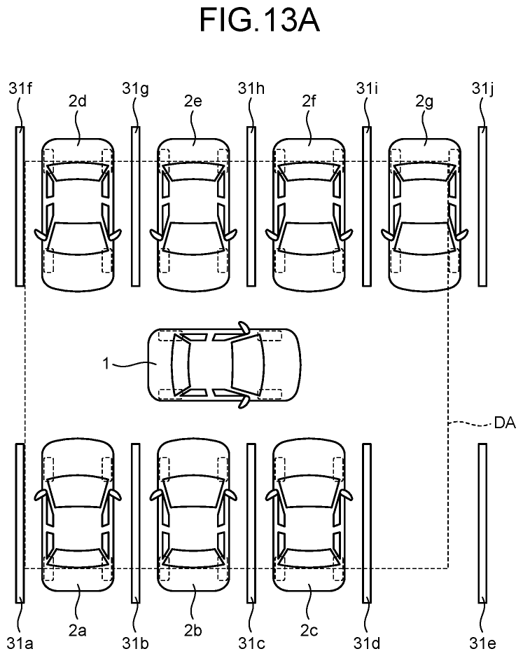

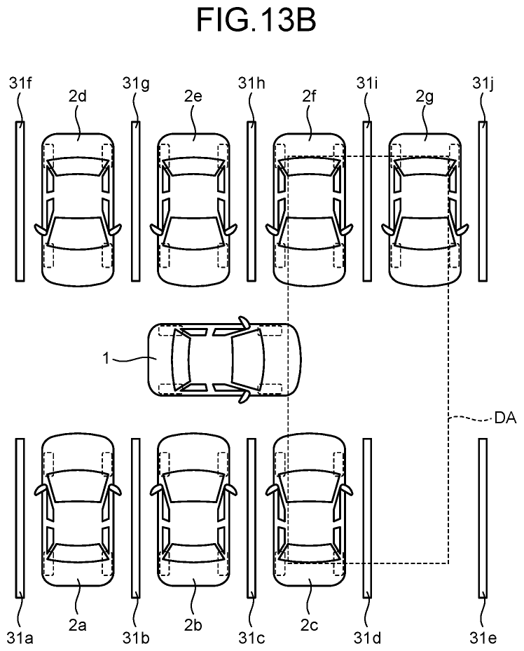

Next, control for suppressing heat generation of the parking assistance ECU 14 related to generation of the peripheral display image will be described with reference to FIGS. 13A and 13B. FIGS. 13A and 13B are diagrams for describing an example of processing of generating a peripheral display image.

The heat generated by the generation of the peripheral display image corresponds to a base load, and when the detection traveling is performed, the heat generated by the sensing of the parking available space is added. When the detection traveling is performed, an image obtained by overlooking four directions of the vehicle 1 may be displayed as in a range indicated by DA in FIG. 13A, or a region to be displayed may be limited to a region ahead of the vehicle to be reduced as in a range indicated by DA in FIG. 13B.

In a case where the entire surrounding of the vehicle 1 is displayed, it is necessary to process all the camera images in the four directions, but when the display range is limited to a region ahead of the vehicle, it is sufficient to process only the image of the front camera. Therefore, the processing amount accompanying the input is reduced. In addition, by reducing the size (the number of pixels) of the display image to be output, the processing amount is reduced, and heat generation is suppressed.

Alternatively, the processing restriction unit 144 may restrict the peripheral display on the basis of the prediction of the temperature of the parking assistance ECU 14 or the change in temperature. For example, while the temperature of the parking assistance ECU is low, the entire surroundings of the vehicle 1 may be displayed as illustrated in FIG. 13A, and when the temperature of the parking assistance ECU 14 is high, only the region ahead of the vehicle 1 may be displayed as illustrated in FIG. 13B.

In a case where the display range is limited to a region ahead of the vehicle, the number of camera images received by the display image generation unit 145 can be reduced. In this case, it can be said that the processing restriction unit 144 performs a restriction such that the number of input pixels of the image processing when the degree of the restriction is strong is lower than the number of input pixels of the image processing when the degree of the restriction is weak.

Moreover, in a case where the size of the display image to be output is reduced or the peripheral display is restricted, it may be said that the processing restriction unit 144 performs a restriction such that the number of output pixels of the image processing when the degree of the restriction is strong is lower than the number of output pixels of the image processing when the degree of the restriction is weak.

In addition, the processing restriction unit 144 may not only restrict the range of the peripheral display but also stop the peripheral display. For example, when performing the detection traveling, the surrounding image may not be displayed, and a message requesting the driver to visually confirm the safety of the surroundings of the vehicle may be output. Then, the surrounding image may be displayed only when a vacant parking frame is detected or when the driver presses the brake, and the detected vacant parking frame may be displayed on a bird's-eye view or an instruction from the driver may be received by a touch panel.

In addition, the processing restriction unit 144 may reduce the frequency of generating the display image as restriction of the peripheral display. The display image generation unit 145 normally generates a still image of 60 frames per second, and continuously displays the still image. This allows the driver to see the moving image.

When the display image generation unit 145 reduces the number of frames to be generated to 30 frames per second or does not update the display image once every two times out of 60 frames to be displayed, the power required for generating the display image can be suppressed to half. Since the vehicle speed is low in the detection traveling and the parking traveling, it is less noticeable even when the update rate (display rate) of the display image is lowered.

In addition, the processing restriction unit 144 may restrict the display rate on the basis of the prediction of the temperature of the parking assistance ECU 14 and the change in temperature. For example, the processing restriction unit 144 may predict the change in temperature of the parking assistance ECU 14, reduce the display rate when it is predicted that the temperature of the chip exceeds the guaranteed operating temperature, and restrict the range to be displayed at the same time.

The process for reducing the display rate is processing of reducing the execution frequency of the image processing. In the above case, it can be said that the processing restriction unit 144 performs processing of making the execution frequency of the image processing when the degree of the restriction is strong smaller than the execution frequency of the image processing when the degree of the restriction is weak.

When the processing amount is reduced in this manner and the prediction of the change in temperature is re-performed in accordance with the reduced amount of heat generated, the time until the temperature of the chip exceeds the guaranteed operating temperature is long or the temperature of the chip does not exceed the guaranteed operating temperature. When the temperature of the chip does not exceed the guaranteed operating temperature as a result of lowering the amount of heat generated of the base load, it is not necessary to further restrict the sensing of the parking available space.

Note that the processing restriction unit 144 may restrict the sensing of the parking available space or restrict the generation of the display image when predicting that the temperature of the chip exceeds the guaranteed operating temperature. In addition, the processing restriction unit 144 may perform both restrictions at the same time when it is predicted that the temperature of the chip exceeds the guaranteed operating temperature.

Next, steering angle control during detection traveling will be described. The parking assistance ECU 14 during the detection traveling can identify the position of the passage in the parking lot by sensing an end point of the parking frame line close to the passage by the white line sensing or by sensing a region where there is no parked vehicle by the free space sensing. Since the parking space is often provided on both sides of the passage, in the present embodiment, the detection traveling control unit 149 causes the vehicle 1 to travel in the center of the passage.

Although the detection traveling does not need to be automatic steering, the parking assistance ECU 14 may assist steering. Specifically, the detection traveling control unit 149 outputs a target steering angle at which the vehicle 1 moves toward the center of the passage to the vehicle control device 12, and when there is no steering torque applied to the steering wheel by the driver, the vehicle control device 12 controls the steering angle in accordance with the target steering angle.

When the steering torque is less than the predetermined threshold value, the vehicle control device 12 applies a reaction force against the steering torque to the steering wheel to maintain the steering angle, and when the steering torque is equal to or larger than the predetermined threshold value, the vehicle control device does not apply the reaction force to the steering wheel and controls the steering angle in accordance with the steering wheel operation of the driver.

In this way, since the vehicle 1 attempts to travel in the center of the passage, the driver is only required to place his/her hand on the steering wheel and manually steer the vehicle only at the branch point or the corner of the passage. In addition, the detection traveling control unit 149 may determine a path to proceed even at the branch point or the corner of the passage, and the steering angle may be automatically controlled.

For example, when the detection traveling control unit 149 limits the vehicle speed during the detection traveling to about 10 km/h so that the vehicle can make an emergency stop by the sensing by the sonar sensor and the automatic brake, there is no problem even in the automatic steering, and the driver can intervene in the steering and move the vehicle in a direction desired to move at any time.

Next, handling of pedal operation during detection traveling and power control will be described. The detection traveling is travel for detecting a parking available place, the detection traveling control unit 149 outputs a vehicle speed control command including a target speed, and the vehicle control device 12 controls the vehicle speed to follow the target speed. However, the driver may intervene in the control of the vehicle speed by operating a pedal during the detection traveling.

For example, when there is a pedestrian in front of the vehicle, the driver may press a brake pedal to temporarily stop the vehicle. In this case, when the sensing is repeated while the vehicle is stopped, only the same result is obtained, and only power is wasted. Therefore, when the vehicle is stopped or the vehicle speed is equal to or less than the threshold value, the processing restriction unit 144 causes the parking frame sensing unit 146 and the space sensing unit 147 to suspend the sensing operation. As a result, it is possible to suppress wasteful power consumption and an increase in the temperature in the parking assistance ECU 14.

In addition, the driver may accelerate by pressing the accelerator pedal. For example, it is better to pass through, in a short time, a section where a vacant parking frame is not found, and when the vehicle approaches a ramp going to the next floor without finding a vacant parking frame, there is no choice but to go up the ramp and go to the next floor. Since it can be estimated that there is no parking available space in the vicinity when the driver accelerates the vehicle, in the present embodiment, the processing restriction unit 144 causes the parking frame sensing unit 146 and the space sensing unit 147 to suspend the sensing operation when the accelerator operation is performed.

In addition, even when no accelerator operation is performed, in a case where the inclination of the vehicle body exceeding the threshold value is detected by the acceleration sensor (not illustrated), the processing restriction unit 144 may determine that the road is a ramp without a parking frame and cause the parking frame sensing unit 146 and the space sensing unit 147 to suspend the sensing operation. Note that a state in which the parking frame sensing unit 146 and the space sensing unit 147 do not perform the sensing process may be referred to as a Stage 0. The parking assistance ECU starts parking assistance when the vehicle deviates from the road. However, for example, the parking assistance ECU does not need to perform detection traveling while the vehicle is traveling on a ramp into an underground parking lot. Therefore, the parking assistance ECU may not perform a sensing process as the Stage 0. When the vehicle speed exceeds a predetermined threshold value (for example, 20 km/h), the Stage 0 may be similarly set.

In addition, when the driver determines that there is no vacant parking frame, the driver may operate the accelerator pedal. Therefore, for example, in a case where the vehicle speed exceeds a predetermined threshold value (for example, 20 km/h) at the time of Stage 1 where the detection traveling is performed, the state management unit 143 may return the stage to Stage 0 and output a message notifying the driver of cancellation of parking assistance via the HMI device 15.

Conversely, when the operation of the accelerator pedal or the brake pedal is in a short time, and does not exceed the threshold value, the state management unit 143 preferably maintains the Stage 1. The detection traveling control unit 149 recovers the speed control when the accelerator pedal or the brake pedal is released.

In the above description, the processing restriction unit 144 causes the parking frame sensing unit 146 and the space sensing unit 147 to suspend the sensing operation when the vehicle is stopped by the brake operation during the detection traveling. The “case where the vehicle is stopped by the brake operation” can be rephrased as the “case where the vehicle speed is less than the predetermined threshold value”.

That is, it can be said that, at the stage of the detection traveling, the processing restriction unit 144 performs processing of increasing the degree of the restriction of the sensing of the parking available space to be applied when the vehicle speed is less than the predetermined threshold value, in comparison with the degree of the restriction to be applied when the vehicle speed is equal to or larger than the predetermined threshold value.

In addition, in the above description, at the stage of the detection traveling, the processing restriction unit 144 causes the parking frame sensing unit 146 and the space sensing unit 147 to suspend the sensing operation when the vehicle speed exceeds the predetermined threshold value or when the occupant steps on the accelerator pedal. That is, it can be said that, at the stage of the detection traveling, the processing restriction unit 144 performs processing of increasing the degree of the restriction of the sensing of the parking available space to be applied when the vehicle speed exceeds the predetermined threshold value or when the acceleration operation by the occupant is performed, in comparison with the degree of the restriction to be applied when the vehicle speed is less than the predetermined threshold value.

Therefore, it can be said that, at the stage of the detection traveling, the processing restriction unit 144 performs processing of increasing the degree of the restriction of the sensing of the parking available space to be applied when the vehicle speed is less than the predetermined threshold value or when the vehicle speed exceeds the second threshold value, in comparison with the degree of the restriction to be applied when the vehicle speed is equal to or larger than the predetermined threshold value and less than the second threshold value.

Processing Performed by Parking Assistance ECU According to First Embodiment

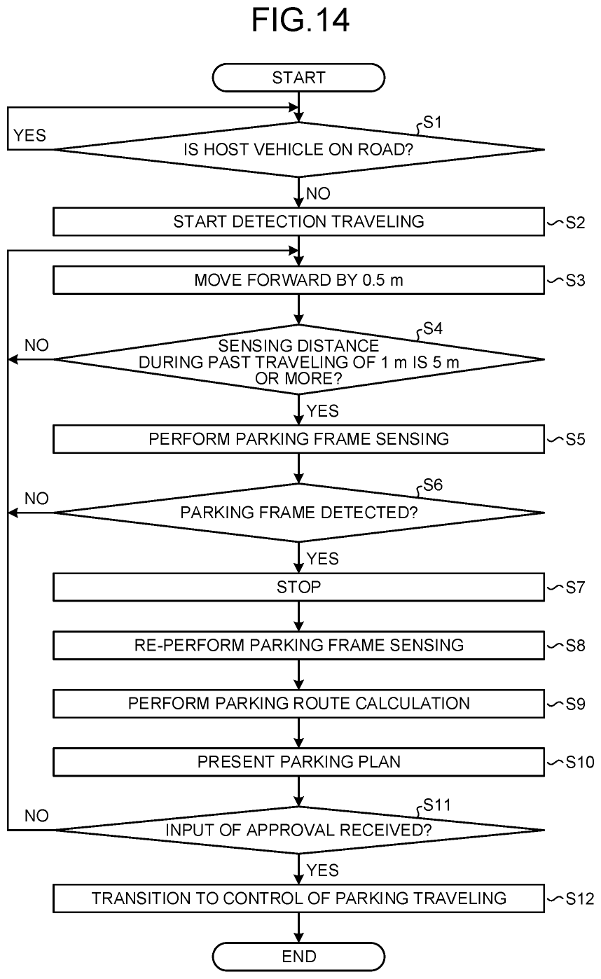

Next, the processing performed by the parking assistance ECU 14 according to the first embodiment will be described. FIG. 14 is a flowchart illustrating an example of processing performed by the parking assistance ECU 14 according to the first embodiment.

First, the state management unit 143 checks whether the vehicle 1 (hereinafter, also referred to as a host vehicle) is present on the road (step S1). The road is not limited to a public road, and may include a private road. When the host vehicle is present on the road (step S1: Yes), since the host vehicle is not present in the parking lot, the process of step S1 is repeated until it is detected that the host vehicle has left the road.

On the other hand, when it is detected that the host vehicle has left the road (step S1: No), the detection traveling control unit 149 sets the target vehicle speed to 16 km/h and activates the side sonars (FRS, FLS, BRS, and BLS) (step S2). That is, the detection traveling control unit 149 starts the detection traveling. In addition, the space sensing unit 147 searches for a region where there is no obstacle within 5.0 m on the side over 1.0 m in the front and rear direction.

Next, for the detection traveling control unit 149, every time the host vehicle moves forward by 0.5 m (step S3), the space sensing unit 147 checks whether the sensing distance during the past traveling of 1.0 m is 5.0 m or more (step S4). When the sensing distance during the past traveling of 1.0 m has been less than 5.0 m (step S4: No), the process proceeds to step S3. That is, the detection traveling control unit 149 repeats the same determination every 0.5 m forward traveling until a space having no obstacle for 1.0 m×5.0 m is detected.

On the other hand, in a case where the sensing distance during traveling of 1.0 m in the past is continuously 5.0 m or more (step S4: Yes), the parking frame sensing unit 146 performs parking frame sensing by the camera 14a or 14b (step S5). Next, the parking frame sensing unit 146 checks whether a parking frame has been detected (step S6).

When no parking frame is detected (step S6: No), the process proceeds to step S3. That is, the space sensing unit 147 and the detection traveling control unit 149 return to repetition of “forward traveling and sensing by the side sonar”. On the other hand, when the parking frame is detected (step S6: Yes), the detection traveling control unit 149 performs control to stop the host vehicle (step S7). Next, the parking frame sensing unit 146 re-performs the parking frame sensing by the camera 14a or 14b (step S8).

Next, the route calculation unit 148 calculates a parking route from the result of the parking frame sensing (step S9). Next, the state management unit 143 displays the parking plan (the target parking position and the parking route) in the display image output by the display image generation unit 145, and requests approval from the driver (step S10). Next, the state management unit 143 checks whether the driver has approved the parking plan (step S11).

When the driver refuses the parking plan (step S11: No), the process proceeds to step S3. That is, the space sensing unit 147 and the detection traveling control unit 149 return to repetition of “forward traveling and sensing by the side sonar”. On the other hand, when the driver approves the parking plan (step S11: Yes), the parking traveling control unit 150 shifts the control to control of the parking traveling (step S12), and ends the process.

Operation and Technical Advantage of First Embodiment

As described above, the parking assistance ECU 14 according to the first embodiment restricts the image processing performed by the parking assistance ECU 14 in accordance with the stage of parking assistance. As a result, it is possible to perform control to restrict an appropriate image processing of each stage of parking assistance and to suppress an increase in the temperature of the chip of the parking assistance ECU 14 that performs the processing. That is, the parking assistance ECU 14 according to the first embodiment can perform parking assistance within a range of a predetermined temperature limit.

In addition, the parking assistance ECU 14 according to the first embodiment increases the degree of the restriction of the image processing to be applied when the stage of the parking assistance is the detection traveling (Stage 1), in comparison with the degree of the restriction to be applied when the stage is the parking traveling (Stage 2). While the parking traveling is a process in which the upper limit of the processing time can be assumed, the detection traveling is a process that is continued until a vacant parking frame is detected, and thus there is a high need to suppress an increase in the temperature of the chip. Therefore, by performing the stronger restriction in the case of the Stage 1, there is a high possibility that a trouble such as the automatic parking being suspended against the intention of the driver in the middle of the automatic parking can be avoided.

In addition, the parking assistance ECU 14 according to the first embodiment restricts the image processing performed by the parking assistance ECU 14 in accordance with the temperature of the chip. As a result, when the temperature of the chip is low, the restriction of the image processing can be alleviated. Therefore, when the temperature of the chip is low, the restriction of the image processing can be avoided, and a situation in which the usability of the driver is impaired can be prevented.

In addition, the parking assistance ECU 14 according to the first embodiment performs processes such as reducing the number of input images that are the basis of the display image, reducing the size (resolution) of the input image or the output image, and reducing the display rate when the restriction of the image processing is strengthened, as compared with when the restriction of the image processing is weakened. Since the amount of heat generated of the chip by the image processing increases as the number of pixels to be processed per unit time increases, the heat generation of the chip can be suppressed by performing the above processing.

In addition, the parking assistance ECU 14 according to the first embodiment performs the image processing of the parking frame sensing only when a space satisfying a predetermined condition is detected on the basis of the information about sensing by the sonar in the detection traveling. Since the space sensing based on the information about sensing by the sonar handles the information (one-dimensional information) about the distance to the obstacle sensed by the sonar sensor, the amount of heat generated is smaller than that of the parking assistance ECU 14 when a two-dimensional image is processed. Therefore, by performing the image processing of the parking frame sensing only when the space satisfying the predetermined condition is detected in the space sensing based on the information about sensing by the sonar, the execution frequency of the image processing of the parking frame sensing can be reduced, and the heat generation of the chip can be suppressed.

In addition, the parking assistance ECU 14 according to the first embodiment restricts the processing for sensing the presence or absence of an obstacle by free space sensing when the obstacle is detected in the traveling direction of the vehicle 1 by the sonar sensor during parking traveling. As a result, the execution frequency of the free space sensing in which the amount of heat generated of the chip is large can be reduced, and the heat generation of the chip can be suppressed.

In addition, the parking assistance ECU 14 according to the first embodiment stops the process for sensing the parking frame when the vehicle speed is less than the predetermined threshold value or when the vehicle speed exceeds the second threshold value in the detection traveling. When the vehicle speed is less than the predetermined threshold value or when the vehicle speed exceeds the second threshold value, it can be estimated that there is no vacant parking frame in the vicinity, and thus the process for sensing the parking frame may not be performed. Therefore, in the above case, the heat generation of the chip can be suppressed by stopping the process for sensing the parking frame.

Note that, in the first embodiment, description is made in which the parking frame sensing by the white line sensing is generally used as the method of sensing the parking available region by the process for the camera image. However, the method of sensing the parking available region is not limited to the method of using the white line sensing. For example, the parking available region may be sensed using another method such as free space sensing. That is, the parking frame sensing in the first embodiment may be replaced with the free space sensing, or the opposite replacement may be performed.

For example, in the case of using the free space sensing, when there is a vacant parking frame, the region between the parking frame lines is identified as a continuous region. Therefore, the space sensing unit 147 compares the size of the region with the vehicle body dimensions (vehicle length×vehicle width), and determines that the parking available region has been detected when the vehicle body can be accommodated.

In the free space sensing, when there is a white line on the road surface, the white line can be detected as one region, when there is a region surrounded by the white lines, the range surrounded by the white lines can be detected as one region, and even when there is no white line on the road surface, the range where the road surface can be continuously detected can be detected as a parking available region. When there are two white lines, the position between the white lines may be set as the target parking position. When there is no white line, the target parking position may be set at the center of the continuous region, or the target parking position may be set at a position about 1.0 m away from the end of the continuous region.

During the detection traveling, the position of the passage may be identified using free space sensing, or an obstacle on the passage may be sensed. When the free space sensing is used, the position of the passage can be identified even in a parking lot where there is no indication of a white line.

Moreover, the obstacle sensing by the sonar sensor has a speed limit such as not functioning at a speed of 20 km/h or more, but the obstacle sensing by the free space sensing has no speed limit. On the other hand, in the obstacle sensing by free space sensing, it is may impossible to discriminate between an obstacle that does not obstruct passage (for example, a stop line), and an obstacle that obstructs passage (for example, a rod-like vehicle stopper). Therefore, when the obstacle is detected by free space sensing, it is preferable to decelerate and perform sensing by a sonar sensor to determine whether it is possible to pass.

### Second Embodiment

In the first embodiment, a mode is described in which the control for suppressing the heat generation of the parking assistance ECU 14 is performed using the information about sensing by the sonar sensor. In the second embodiment, control is performed to suppress heat generation of the parking assistance ECU 14 by controlling the free space sensing while using the free space sensing.

In the following description, points different from the above-described embodiment will be mainly described, and detailed description of points common to the contents already described will be omitted. In addition, each embodiment described below may be implemented individually, or may be implemented in appropriate combination.

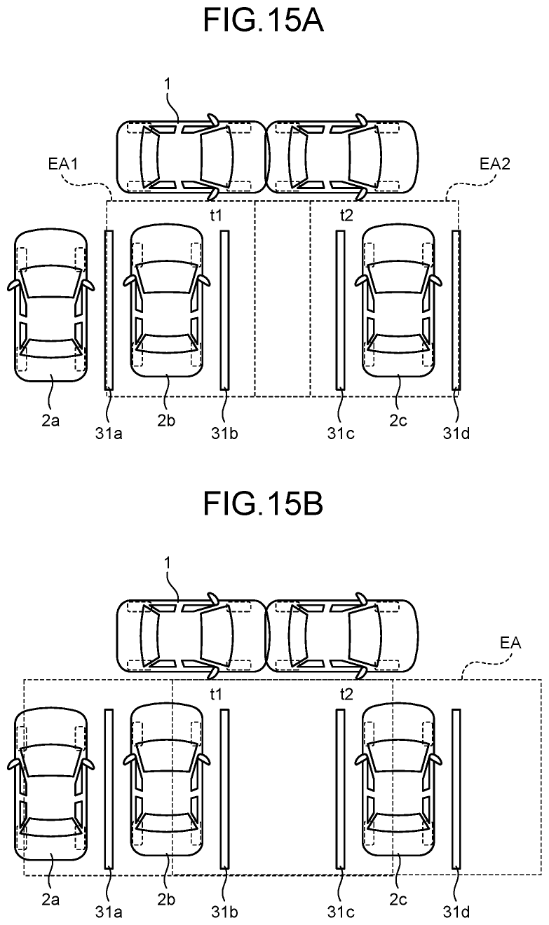

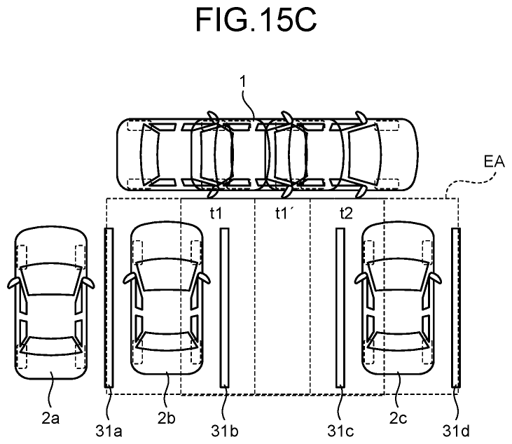

First, control for suppressing heat generation by the parking assistance ECU 14 by restricting the vehicle speed of the vehicle 1 will be described with reference to FIGS. 15A to 15C. FIGS. 15A to 15C are diagrams for describing an example of a parking frame sensing process using free space sensing.

FIG. 15A illustrates a sensing range EA1 when the free space sensing is performed at time t1 and a sensing range EA2 when the free space sensing is performed at next time t2 when the vehicle 1 performs detection traveling while performing the free space sensing at regular time intervals with the rectangular region on the side of the vehicle 1 as the sensing range. As illustrated in FIG. 15A, since a free space in which one vehicle is accommodated is not included in each of two consecutive sensing range EA1 and sensing range EA2, the vehicle 1 overlooks the vacant parking frame.

As illustrated in FIG. 15B, when the sensing range at the time of performing the free space sensing is widened in the front-rear direction, it is difficult to overlook the vacant parking frame. However, when the sensing range is widened, the number of pixels processed per unit time increases, and the temperature of the parking assistance ECU 14 increases.

Additionally, as illustrated in FIG. 15C, when the time interval at which the free space sensing is performed is shortened and the free space sensing is performed even at time t1′ which is an intermediate time between time t1 and time t2, it is difficult to overlook the vacant parking frame. However, when the sensing interval is shortened, the number of pixels processed per unit time increases, and the temperature of the parking assistance ECU 14 increases.

When the conditions for overlooking the vacant parking frame are considered, the overlooking of the vacant parking frame occurs when the overlapping rate of the sensing ranges is low. When the vehicle speed of the vehicle 1 is high, the overlapping rate of the sensing ranges becomes lower. Therefore, in the present embodiment, the processing restriction unit 144 prevents overlooking of the vacant parking frame by suppressing the vehicle speed.

In addition, when the vehicle speed is lowered, the time until the vehicle 1 encounters the vacant parking frame becomes longer. Therefore, the processing restriction unit 144 may restrict the vehicle speed in accordance with the chip temperature, and may not restrict the vehicle speed while the chip temperature has a margin. For example, while the chip temperature is low and the temperature margin is large, or while the time margin until reaching the guaranteed operating temperature is large (it may be determined by whether the time from the start of free space sensing is less than a predetermined time threshold value), the sensing interval is shortened or the sensing range is widened so as to prevent overlooking even when the vehicle speed is high. On the other hand, when the chip temperature increases and the time margin or the temperature margin decreases, the processing restriction unit 144 restricts the vehicle speed so as not to overlook the frame.

In the above case, it can be said that the processing restriction unit 144 performs processing of lowering the vehicle speed when the degree of the restriction is strong, in comparison with the vehicle speed when the degree of the restriction is weak.

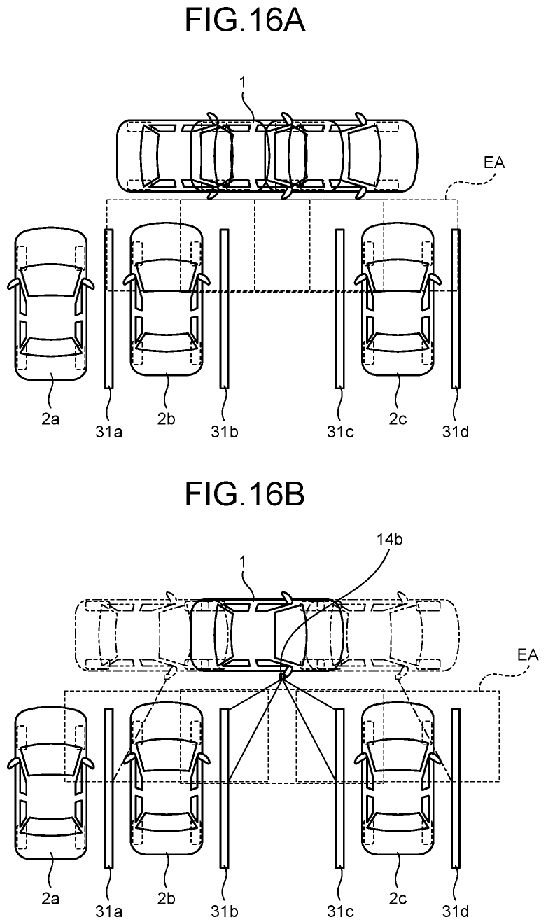

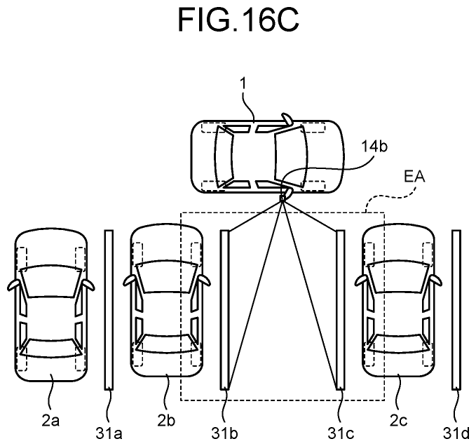

Note that the processing restriction unit 144 may shorten the sensing range on the side of the vehicle 1 by the parking frame sensing unit 146 in the vehicle width direction. Hereinafter, control for suppressing heat generation by the parking assistance ECU 14 by restricting the sensing range will be described with reference to FIGS. 16A to 16C. FIGS. 16A to 16C are diagrams for describing an example of processing of restricting the sensing range of the parking frame sensing unit 146.

As illustrated in FIG. 16A, when a sensing range EA is shortened in the vehicle width direction, only a half of the parking frame is sensed in the sensing range EA. Therefore, even when the free space is sensed, it cannot be determined whether the vehicle body is accommodated there. However, since it can be determined whether there is a parked vehicle on the side, the determination as to whether the vehicle body is accommodated may be performed by another sensing. For example, in response to determining that there is a space where no parked vehicle is present on the side, the processing restriction unit 144 widens the sensing region EA, re-performs the free space sensing, and determines whether the vehicle body is accommodated in the free space as illustrated in FIG. 16C.

Shortening or lengthening the sensing range on the side of the vehicle 1 by the parking frame sensing unit 146 in the vehicle width direction corresponds to changing the number of input pixels or the number of output pixels of the image processing. Moreover, in this case, it can be said that the processing restriction unit 144 changes the sensing range on the basis of a situation around the vehicle such as whether there is a parked vehicle on the side.

Therefore, it can be said that the processing restriction unit 144 changes the number of input pixels or the number of output pixels of the image processing on the basis of the situation around the vehicle sensed by the sensing unit, and performs processing of making the number of input pixels or the number of output pixels of the image processing larger when a candidate for the parking available space is detected than when a candidate for the parking available space is not detected.

Even when the parking frame sensing unit 146 performs the parking frame sensing by the white line sensing, as illustrated in FIG. 16B, the range where the white line sensing is performed may be restricted to the sensing range EA on the side of the vehicle 1, and the range to be the input image of the white line sensing may be shortened in the vehicle width direction. When a white line is sensed in front of a parking frame in which there is no parked vehicle, two (a pair of) white lines extending to the end of the sensing range can be sensed. On the other hand, when a white line is sensed in front of a parking frame in which there is a parked vehicle, a portion at the end of the sensing range for at least one white line is hidden by the parked vehicle. Therefore, it can be determined that the white line is not a parking frame in which parking is available.

Also in this case, at the time point when the pair of white lines extending to the end of the sensing range is detected, as illustrated in FIG. 16C, the parking frame sensing unit 146 performs the parking frame sensing by expanding the sensing range, and determines whether the paired white lines are visible to the depth of the parking frame. In addition, the parking frame sensing unit 146 may perform free space sensing in the same range to determine whether there is an obstacle in the parking frame.

As described above, when the sensing range is narrowed, the power consumption can be suppressed, but when the sensing range is kept narrowed, appropriate detection traveling may not be performed. For example, when the vehicle 1 senses only the right side of the passage, there is a possibility that the left parking frame is overlooked or the passage ahead of the vehicle is erroneously identified as a parking frame.

Therefore, in the present embodiment, the parking frame sensing unit 146 intermittently inserts the sensing in which the sensing range is widened between operations of the sensing in which the range is narrowed. For example, when a frame line is periodically sensed only on the left side, and a parking frame sensing is performed or a free space sensing is performed for a wide range ahead of the vehicle at time intervals for a time longer than the time interval at which the frame line is sensed, it is possible to determine whether there is a parking frame on the right side or whether there is a cross ahead. Therefore, it is possible to cope with a change in the situation. For example, in response to determining that there is a cross ahead and a passage with parking frames on the left and right continues ahead of the cross, the vehicle 1 may enter the center of the passage ahead and proceed while sensing the left and right parking spaces.

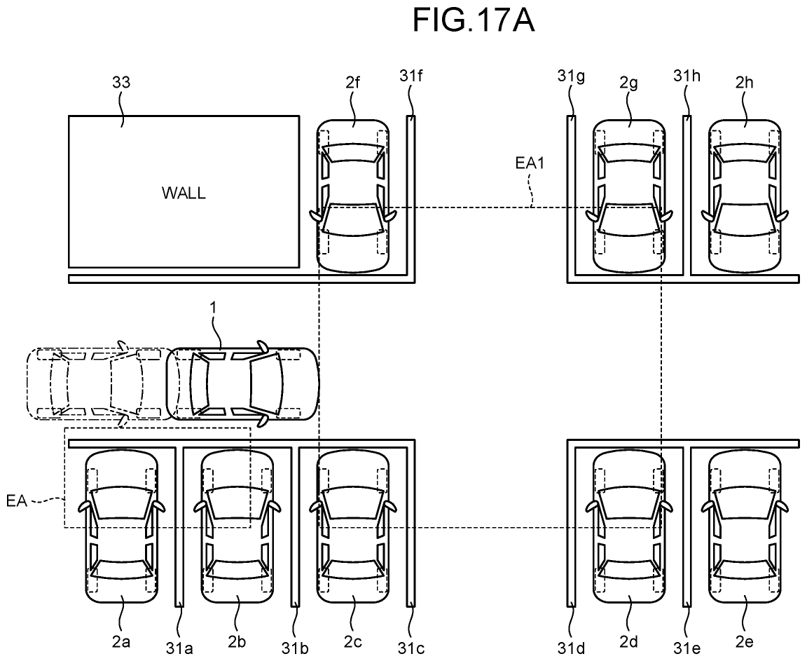

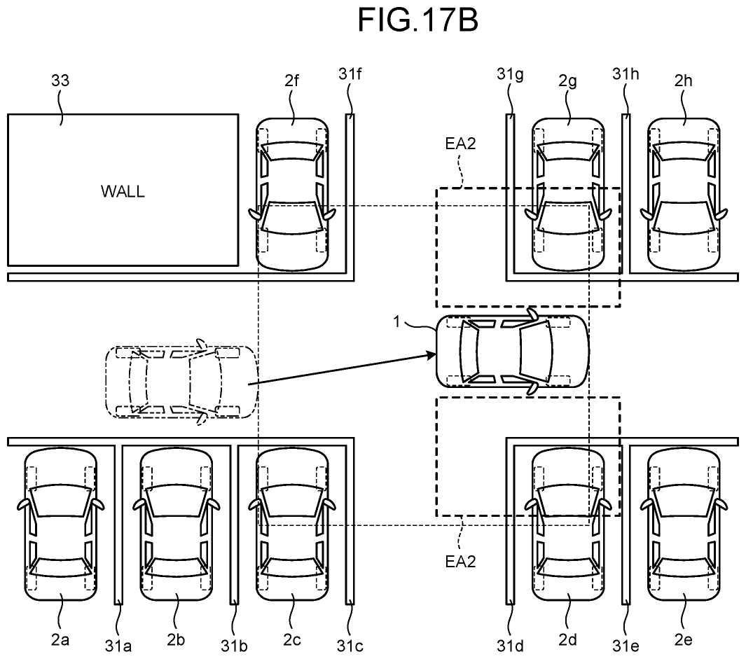

Note that the sensing range may not be fixed, and large and small sensing ranges may be mixed. When the large and small sensing ranges are mixed, the sensing intervals need not be set at equal intervals. Hereinafter, detection traveling in a case where the large and small sensing ranges are mixed will be described with reference to FIGS. 17A and 17B. FIGS. 17A and 17B are diagrams for describing an example of detection traveling in a case where large and small sensing ranges are mixed.

For example, in a case where sensing is performed in a wide (or large) sensing range EA1 as illustrated in FIG. 17A, the sensing is performed farther than that in a case where sensing is performed in a narrow (or small) sensing range EA2 as illustrated in FIG. 17B. Therefore, a distance to the position to be sensed next or a time until the next sensing may be increased. In addition, the position to be sensed such that the width in which the wide sensing range and the narrow sensing range overlap with one another is constant.

In a case where the large and small sensing ranges are mixed, the size of the region to be subjected to the parking frame sensing in the sensing image used for the parking frame sensing or the camera image changes. That is, the number of input pixels of the sensing image processing changes. Moreover, in a case where the sensing image is generated, the number of input pixels and the number of output pixels of the image processing of generating the sensing image also change.

In addition, in a case where the parking frame sensing unit 146 performs parking frame sensing for a wide sensing range, it can be said that the processing restriction unit 144 performs processing of increasing a distance to the position to be sensed next or a time until the next sensing.

Therefore, when the processing restriction unit 144 changes the interval of the image processing and the number of input pixels or the number of output pixels of the image processing and increases the number of input pixels or the number of output pixels of the image processing, it can be said that the process for increasing the interval of the image processing is performed.

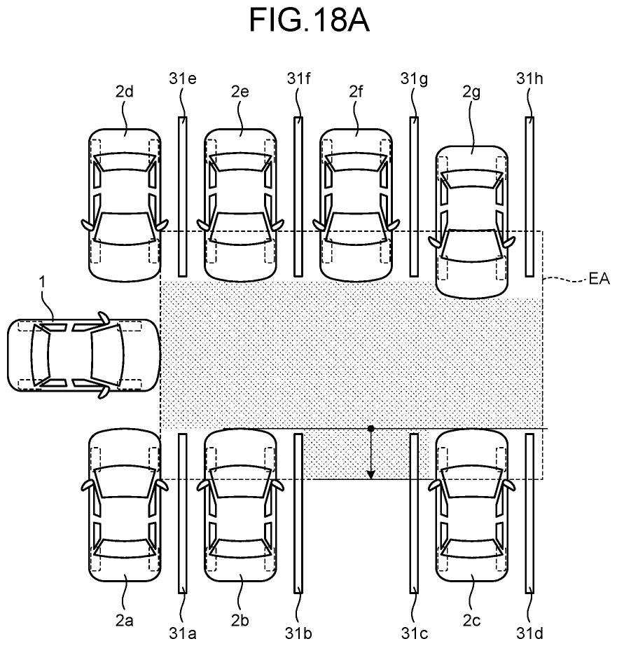

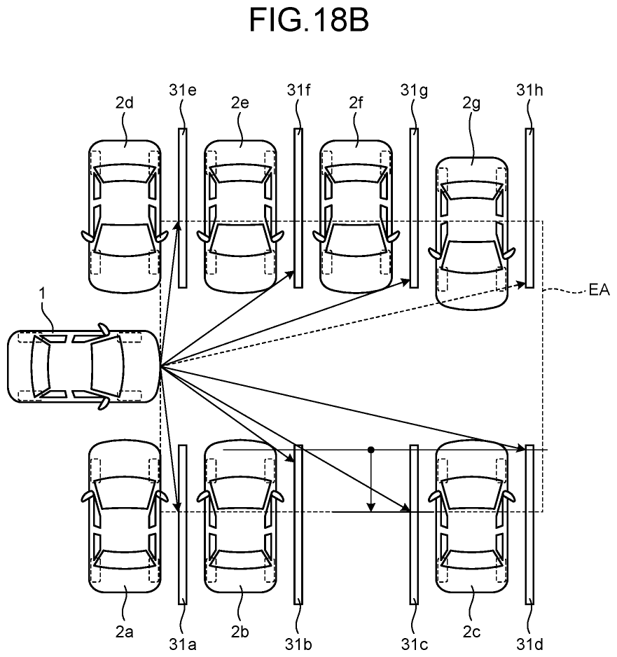

Next, control for suppressing heat generation of the parking assistance ECU 14 in the process for determining presence or absence of a parked vehicle will be described with reference to FIGS. 18A and 18B. FIGS. 18A and 18B are diagrams illustrating an example of processing of determining presence or absence of a parked vehicle.

The criterion for determining that there is no vacant parking frame may be rephrased as the sensing result being that a parked vehicle is within an expected range. Means for sensing the presence or absence of a parked vehicle may be free space sensing or parking frame sensing (white line sensing). For example, when free space sensing is performed for the sensing range EA illustrated in FIG. 18A, a range where the road surface is not hidden by the parked vehicle is sensed as a free space.

In the case of FIG. 18A, the free space spreads in the lateral direction of the portion of the second frame, right ahead of the vehicle 1 (host vehicle). The free space herein spreads largely outward, compared to the first frame and the second frame in which parked vehicles are present, left ahead of the vehicle 1, and the first frame, right ahead of the vehicle 1. When there is a vehicle parked in the second frame ahead of the vehicle, there should have been no spreading of the free space. Therefore, when the protruding width of the free space exceeds the predetermined threshold value, it can be estimated that there is no parked vehicle.

FIG. 18B is an explanatory diagram of an example of determining the presence or absence of a parked vehicle by white line sensing. As illustrated in FIG. 18B, when the white line is sensed in the sensing region EA in the frame of the dotted line, the white line can be detected in a range not shielded by the parked vehicle.

For example, with the left and right white lines near the host vehicle amount as the first one, for the third white line left ahead of the vehicle, only distal end portion can be seen, whereas for the third white line right ahead of the vehicle, a long white line can be detected. This is longer than the length of the white line detected when there is a parked vehicle in the second frame right ahead. Therefore, when the length of the detected white line exceeds the threshold value, it can be determined that there is no parked vehicle before the white line, that is, in the second frame right ahead. In the case illustrated in FIGS. 18A and 18B, there are parked vehicles in the left and right first frames ahead of the host vehicle, so that there is no need to repeat sensing while the vehicle moves forward by one frame. Rather, it is preferable to determine that the second frame right ahead is a vacant parking frame candidate, and to set the point to be sensed next to before the second frame right ahead.

Processing Performed by Parking Assistance ECU According to Second Embodiment

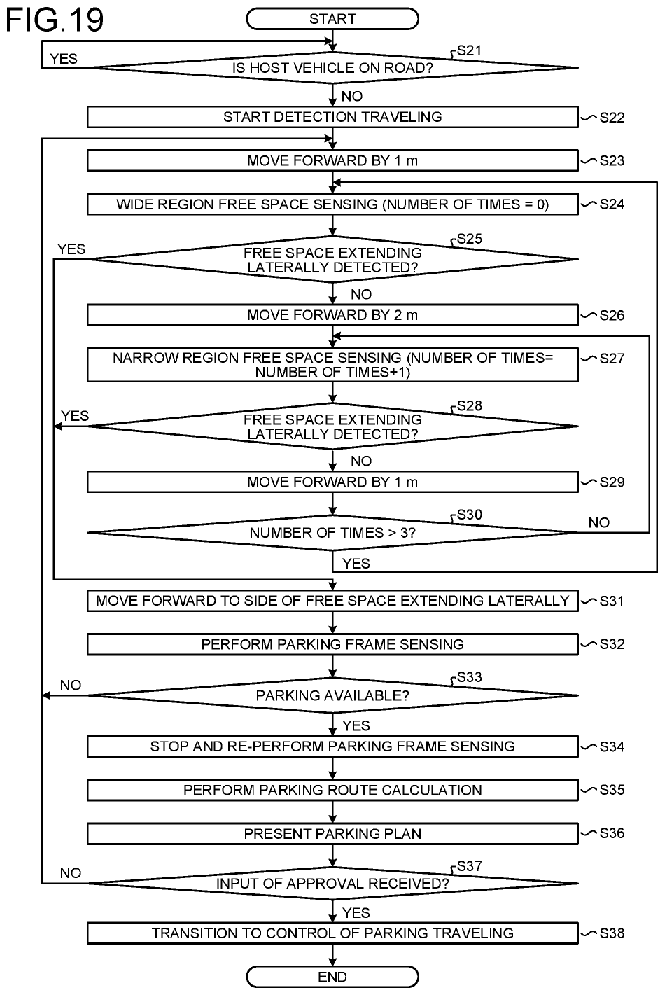

Next, the processing performed by the parking assistance ECU 14 according to the second embodiment will be described. FIG. 19 is a flowchart illustrating an example of processing performed by the parking assistance ECU 14 according to the second embodiment. In the description of the flowchart of FIG. 19, the description may be omitted when the processing is the same as that of the flowchart of FIG. 14. For example, since the process in step S21 in FIG. 19 is similar to the process in step S1 in FIG. 14, the description thereof will be omitted.

In response to determining in step S21 that the host vehicle has left the road (step S21: No), the detection traveling control unit 149 sets the target vehicle speed to 16 km/h (step S22). Δt the same time, the parking frame sensing unit 146 starts free space sensing. That is, the detection traveling control unit 149 starts the detection traveling.

In addition, when there is no detection of a predetermined free space, the parking frame sensing unit 146 repeatedly moves forward by a predetermined distance and performs the free space sensing. In the present embodiment, there are two types of ranges for which free space sensing is performed: a wide range (range of 6.0 m in the front-rear direction) and a narrow range (range of 3.0 m in the front-rear direction), and the predetermined distance to move forward is 2.0 m after the wide range sensing and 1.0 m after the narrow range sensing.

For example, when the detection traveling control unit 149 moves the host vehicle forward by 1.0 m (step S23), the parking frame sensing unit 146 performs wide-region free space sensing and resets the counter of the number of times to 0 (step S24).

Next, the parking frame sensing unit 146 checks whether a free space extending laterally has been detected (step S25). When a free space extending laterally is detected (step S25: Yes), the process proceeds to step S31.

On the other hand, when the free space extending laterally is not detected (step S25: No), the detection traveling control unit 149 performs the next sensing when the host vehicle is moved forward by 2.0 m (step S26). The reason why the distance to the place where the sensing is performed next is long is that since the wide-region free space sensing has been performed, it has been found that there is no predetermined free space in a wider range. The parking frame sensing unit 146 performs narrow region free space sensing (step S27). Δt this time, the parking frame sensing unit 146 performs processing of incrementing the number of times (the number of times of free space sensing) by 1.

Next, the parking frame sensing unit 146 checks whether a free space extending laterally has been detected (step S28). When a free space extending laterally is detected (step S28: Yes), the process proceeds to step S31. On the other hand, when the free space extending laterally is not detected (step S28: No), the detection traveling control unit 149 performs control to move the host vehicle forward by 1.0 m (step S29).

Next, the parking frame sensing unit 146 checks whether the number of times exceeds 3 (step S30). When the number of times is 3 or less (step S30: No), the process proceeds to step S27. On the other hand, when the number of times exceeds 3 (step S30: Yes), the process proceeds to step S24. That is, when the number of times is 3 or less narrow region free space sensing is repeated, and when the number of times exceeds 3, wide-region free space sensing is performed. As a whole, free space sensing is repeated in a predetermined range every time moving forward by a predetermined distance until a free space extending laterally is detected.

When the parking frame sensing unit 146 detects the free space extending laterally (step S25: Yes, and step S28: Yes), the detection traveling control unit 149 performs control to move forward the vehicle to the side of the free space extending laterally (step S31).

When the cameras 14a and 14b have moved forward to the side of the free space extending laterally, the parking frame sensing unit 146 performs parking frame sensing by the camera 14a or 14b (step S32). Instead of the parking frame sensing, it may be sensed with the free space sensing whether there is a space (that is, a region where a road surface having a width equal to or larger than the vehicle width and a depth equal to or larger than the vehicle length is visible) having a size that allows parking, or the free space sensing may be performed when the white line was not sensed with the parking frame sensing. As described above, by using the free space sensing as an alternative means, it is possible to detect a parking available space even in a parking lot where there is no indication of a white line. Next, the parking frame sensing unit 146 checks whether parking is available (step S33). When parking is not available (step S33: No), the process proceeds to step S23. That is, the parking frame sensing unit 146 and the detection traveling control unit 149 return to the repetition of “forward movement and free space sensing”.

On the other hand, when parking is available (step S33: Yes), the detection traveling control unit 149 stops the host vehicle and then re-performs the parking frame sensing in order to increase the sensing accuracy (step S34). Processing subsequent to the parking route calculation is similar to the processing in steps S9 to S12 in FIG. 14, and thus description thereof is omitted.

Operation and Technical Advantage of Second Embodiment

As described above, the parking assistance ECU 14 according to the second embodiment senses the vacant parking frame using the free space sensing. According to the parking assistance ECU 14 according to the second embodiment, since the free space sensing is used, it is possible to detect a parking available space even in a parking lot where there is no indication of a white line. In addition, since there is no speed limit in the free space sensing, the process for sensing a vacant parking frame can be performed even when the vehicle speed is relatively high.

In addition, the parking assistance ECU 14 according to the second embodiment performs processing of lowering the vehicle speed of the vehicle 1 when the degree of the restriction is strong, in comparison with the vehicle speed of the vehicle 1 when the degree of the restriction is weak. With this processing, the possibility of overlooking the vacant parking frame can be reduced. In addition, when the vehicle speed is lowered, the time until the vehicle encounters the vacant parking frame is long. However, in a case where there is time to spare until the temperature of the chip reaches the guaranteed operating temperature, the degree of lowering the vehicle speed may be reduced. That is, the parking assistance ECU 14 according to the second embodiment can perform parking assistance within a range of a predetermined temperature limit without impairing the sense of use of the driver.

In addition, the parking assistance ECU 14 according to the second embodiment periodically changes the range of the camera image used for the parking frame sensing or the size of the sensing image, and when the parking frame sensing is performed in a wide sensing range, performs processing of increasing the distance to the position to be sensed next or the time until the next sensing. This is because, when parking frame sensing is performed in a wide range, sensing can be performed for a far position. Therefore, even when a distance to the position to be sensed next or a time until the next sensing is increased, it is difficult to overlook the vacant parking frame. By increasing the time until the next sensing, the amount of heat generated of the chip per unit time is reduced. Therefore, the rise in temperature of the chip can be suppressed.

In addition, the parking assistance ECU 14 according to the second embodiment performs processing of shortening or lengthening the sensing range on the side of the vehicle 1 in the vehicle width direction on the basis of whether there is a parked vehicle on the side. When the sensing range on the side of the vehicle 1 is shortened in the vehicle width direction, the number of pixels to be processed per unit time is reduced. Therefore, heat generation of the chip can be suppressed. However, in a case where the free space sensing is performed, when the sensing range on the side of the vehicle 1 is shortened in the vehicle width direction, it is not possible to determine whether the vehicle body is accommodated in the free space. Even in this case, it is possible to determine whether there is a parked vehicle on the side. Therefore, when the free space sensing is performed in a state where the lateral sensing range is shortened in the vehicle width direction, and there is a parked vehicle on the side, the sensing range may be lengthened in the vehicle width direction, and the free space sensing may be performed again, or the parking frame sensing may be performed to confirm that the parking frame can be seen to its depth. In this way, it is possible to perform the process for sensing the vacant parking frame while suppressing the heat generation of the chip.

### Third Embodiment

In the first embodiment and the second embodiment, a mode is described in which positions to be sensed by the parking frame sensing unit 146 and the space sensing unit 147 are mechanically determined by, for example, defining an overlapping width of sensing ranges. However, the position to be sensed may be dynamically determined in accordance with the sensing result by the parking frame sensing unit 146 and the space sensing unit 147.

In the following description, points different from the above-described embodiment will be mainly described, and detailed description of points common to the contents already described will be omitted. In addition, each embodiment described below may be implemented individually, or may be implemented in appropriate combination.

In the third embodiment, as a method of determining the presence or absence of a parked vehicle, a method of sensing an image of part of a vehicle body of the parked vehicle, specifically, an image of a license plate of the parked vehicle is used. Since it is decided that the license plate is presented at the front and the back of the vehicle, when an image of the license plate is detected, it can be determined that there is a vehicle.

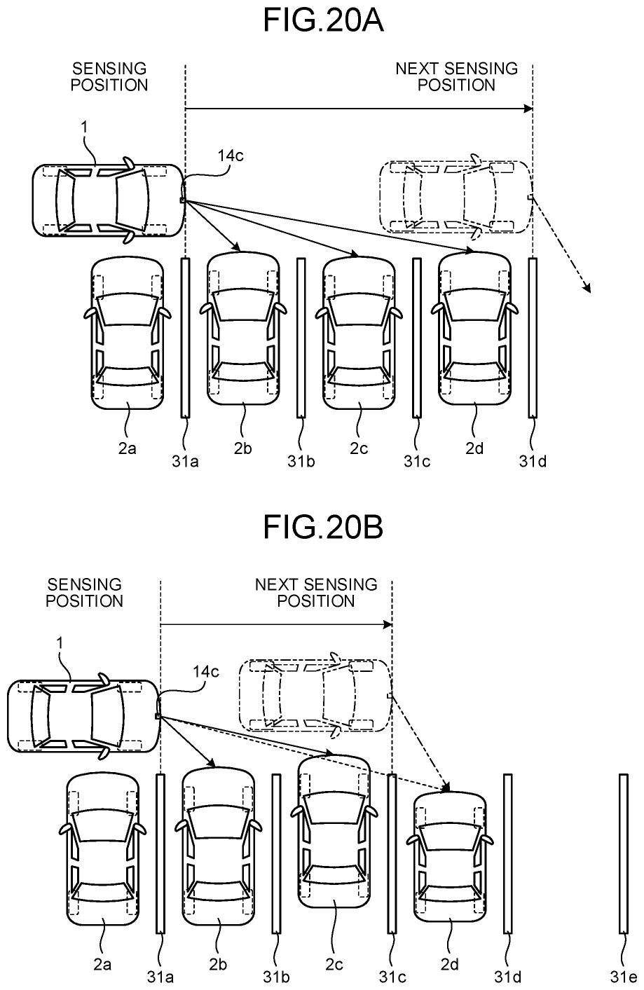

Hereinafter, processing of determining the presence or absence of a parked vehicle by sensing an image of a license plate of the parked vehicle will be described with reference to FIGS. 20A and 20B. FIGS. 20A and 20B are diagrams for describing an example of processing of determining the presence or absence of a parked vehicle by sensing an image of a license plate of the parked vehicle.

In the case of FIG. 20A, since the license plates of up to the third parked vehicle (parked vehicles 2a to 2c) right ahead are visible, it can be determined that three parking frames are not vacant parking frames. Therefore, the position where the license plate is searched for next (next sensing position) may be a position advanced by three parking frames, and when there is no detection of the license plate there, the parking frame sensing unit 146 performs parking frame sensing or free space sensing.

In addition, in the case of FIG. 20B, since a third parked vehicle 2d right ahead is shielded by the parked vehicle 2c that is parked out of the frame, only the license plate up to the second parked vehicle 2b can be seen. Therefore, the parking frame sensing unit 146 senses the license plate with a position advanced by two parking frames as the next sensing position. In this manner, the processing amount can be reduced as quickly as possible by identifying a section having no vacant parking frame and skipping sensing of the section where there is no vacant parking frame.

Performing sensing of the license plate can be said to be sensing a situation around the vehicle such as whether there is a parked vehicle around the vehicle 1. That is, it can be said that the parking frame sensing unit 146 senses the situation around the vehicle. In addition, it can be said that the parking frame sensing unit 146 identifies a section having no vacant parking frame, that is, a range having no parking available space, on the basis of the presence or absence of detection of a parked vehicle.

Therefore, in the above case, it can be said that the processing restriction unit 144 identifies a range where the parking available space is not present on the basis of the situation around the vehicle sensed by the sensing unit, and performs processing of stopping the image processing of sensing the parking available space when the vehicle 1 is in the range where the parking available space is not present.

Operation and Technical Advantage of Third Embodiment

As described above, the parking assistance ECU 14 according to the third embodiment can identify a section having no vacant parking frame and stop sensing of the section identified as having no vacant parking frame. As a result, the processing amount by the parking assistance ECU 14 can be reduced as quickly as possible, and the heat generation of the parking assistance ECU 14 can be suppressed.

In addition, the parking assistance ECU 14 according to the third embodiment determines the presence or absence of a parked vehicle by sensing an image of a license plate of the parked vehicle. The color and shape of the license plate are determined, and the license plate appears as a rectangular image on the camera image. Therefore, the license plate on the camera image is easily recognized, and the parked vehicle can be efficiently sensed.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

The parking assistance device according to the present disclosure is able to implement efficient parking assistance within a range of a predetermined temperature limit.

What is claimed is:

1. A parking assistance device comprising
a hardware processor coupled to a memory and configured to:
receive a camera image;
perform image processing with the camera image as an input;
sense a situation around a vehicle on the basis of the camera image or a sensing image generated by the image processing;
perform parking assistance including a plurality of stages on the basis of the situation around the vehicle; and
restrict the image processing in accordance with the stages.

2. The parking assistance device according to claim 1, wherein the hardware processor is configured to increase a degree of the restriction to be applied to a stage of detection traveling in which a vehicle travels for a purpose of detecting a parking available space, the degree of the restriction being increased in comparison with a degree of the restriction to be applied to a stage of parking traveling in which a vehicle travels to a target parking position identified in the parking available space.

3. The parking assistance device according to claim 1, wherein the hardware processor is configured to
sense a temperature of the parking assistance device, and
restrict the image processing in accordance with the temperature.

4. The parking assistance device according to claim 3, wherein the hardware processor is configured to
predict a change in the temperature on the basis of the temperature, and
increase a degree of the restriction to be applied in response to determining that a prediction value of the temperature exceeds a predetermined temperature limit, the degree of the restriction being increased in comparison with a degree of the restriction to be applied in response to determining that the prediction value of the temperature does not exceed the predetermined temperature limit.

5. The parking assistance device according to claim 2, wherein the hardware processor is configured to perform one of:
processing of making the number of input pixels of the image processing when a degree of the restriction is increased smaller than the number of input pixels of the image processing when a degree of the restriction is weak,
processing of making the number of output pixels of the image processing when a degree of the restriction is increased smaller than the number of output pixels of the image processing when a degree of the restriction is weak, and
processing of making an execution frequency of the image processing when a degree of the restriction is increased smaller than an execution frequency of the image processing when a degree of the restriction is weak.

6. The parking assistance device according to claim 4, wherein the hardware processor is configured to perform one of:
processing of making the number of input pixels of the image processing when a degree of the restriction is increased smaller than the number of input pixels of the image processing when a degree of the restriction is weak,
processing of making the number of output pixels of the image processing when a degree of the restriction is increased smaller than the number of output pixels of the image processing when a degree of the restriction is weak, and
processing of making an execution frequency of the image processing when a degree of the restriction is increased smaller than an execution frequency of the image processing when a degree of the restriction is weak.

7. The parking assistance device according to claim 2, wherein the hardware processor is configured to perform a restriction by lowering a vehicle speed when a degree of the restriction is increased, in comparison with a vehicle speed when a degree of the restriction is weak.

8. The parking assistance device according to claim 4, wherein the hardware processor is configured to perform a restriction by lowering a vehicle speed when a degree of the restriction is increased, in comparison with a vehicle speed when a degree of the restriction is weak.

9. The parking assistance device according to claim 1, wherein the hardware processor is configured to
change an interval of the image processing, and the number of input pixels or output pixels of the image processing, and
increase an interval of the image processing when the number of input pixels or output pixels of the image processing is increased.

10. The parking assistance device according to claim 1, wherein the hardware processor is configured to
change the number of input pixels or output pixels of the image processing on the basis of the situation around the vehicle, and
increase the number of input pixels or output pixels of the image processing when a candidate for a parking available space is detected, in comparison with when a candidate for the parking available space is not detected.

11. The parking assistance device according to claim 10, wherein the hardware processor is configured to
identify a range where the parking available space is not present on the basis of the situation around the vehicle, and
stop or restrict image processing of sensing the parking available space when a vehicle is in the range where the parking available space is not present.

12. A parking assistance device comprising
a hardware processor coupled to a memory and configured to:
receive a camera image;
receive sensing information including distance information;
perform, with the camera image as an input, image processing of sensing a parking available space;
sense a space satisfying a predetermined condition on the basis of the sensing information;
stop or restrict the image processing of sensing the parking available space when the space satisfying the predetermined condition is being sensed on the basis of the sensing information; and
perform the image processing of sensing the parking available space when the space satisfying the predetermined condition has been detected on the basis of the sensing information.

13. The parking assistance device according to claim 1, wherein the hardware processor is configured to
sense a road surface region by performing image processing with a camera image as an input,
receive sensing information including distance information, and
increase a degree of restriction to be applied to sensing of the road surface region in the image processing when an obstacle on a path of a vehicle is being sensed on the basis of the sensing information, in comparison with when an obstacle on the path is not being sensed on the basis of the sensing information.

14. The parking assistance device according to claim 10, wherein the hardware processor is configured to
restrict the image processing on the basis of the stages and a status of the vehicle, and
increase a degree of restriction to be applied to the sensing of the parking available space when a vehicle speed is less than a predetermined threshold value, or when the vehicle speed exceeds a second threshold value, or when an acceleration operation by an occupant is being performed at a stage of detection traveling, the degree of the restriction being increased in comparison with when the vehicle speed is equal to or larger than the predetermined threshold value and less than the second threshold value.

15. A parking assistance method implemented by a computer performing parking assistance for a vehicle, the parking assistance method comprising:
receiving a camera image;
performing image processing with the camera image as an input;
sensing a situation around a vehicle on the basis of the camera image or a sensing image generated by the image processing;
performing parking assistance including a plurality of stages on the basis of the situation around the vehicle; and
restricting the image processing in accordance with the stages.

16. A parking assistance method implemented by a computer performing parking assistance for a vehicle, the parking assistance method comprising:
receiving a camera image;
receiving sensing information different from the camera image;
performing image processing with the camera image as an input, the image processing including sensing a parking available space on the basis of a camera image or a sensing image generated with the camera image as an input;
stopping or restricting image processing of sensing the parking available space when the parking available space is being sensed on the basis of the sensing information; and
performing the image processing of sensing the parking available space when a candidate for the parking available space has been detected on the basis of the sensing information.
